(19) United States
(12) Patent Application Publication
(10) Pub. No.: US 2007/0014397 A1
(43) Pub. Date: Jan. 18, 2007

(54) Storage device and information processing device

(76) Inventors: Masaharu Ukeda, Yokohama (JP); Satoshi Yoshida, Tachikawa (JP); Yoshinori Mochizuki, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/478,628

(22) Filed: Jul. 3, 2006

(30) Foreign Application Priority Data
Jul. 6, 2005 (JP) 2005-196995

(51) Int. Cl. H04L 9/30; G06F 12/00

(52) U.S. Cl. 380/30; 711/103; 711/115

(57) ABSTRACT

A memory card, which is a storage device connectable to a terminal, includes a buffer memory in which externally-provided data is stored, a flash memory, and a controller which controls reading and writing of data from and to these memories. The controller saves a divided input data in the non-volatile memory in accordance with a result of determination regarding data size information contained in a first divided input data of data externally inputted for a security process and a data management size of the storage device, and the controller reads the saved data to the memory for performing the security process when it receives an n-th divided input data.

### CROSS-REFERENCE TO RELATED APPLICATION

The present application claims priority from Japanese Patent Application No. JP 2005-196995 filed on Jul. 6, 2005, the content of which is hereby incorporated by reference into this application.

### TECHNICAL FIELD OF THE INVENTION

The present invention relates to technologies for a storage device with a license information management function and an information processing device using the storage device to handle license information.

### BACKGROUND OF THE INVENTION

In recent years, DRM (Digital Rights Management) system technology regarding content data distribution and license information management between terminal devices and storage devices has been demanded. DRM covers protection and management of license information (rights information) of electronic content data.

U.S. Patent Publication No. 2005-0120232 (JP-A-2002-163396) discloses a technology regarding a method for managing a license key for each security level so that the license key distributed with high security level is not distributed with low security level in the case where systems with different security levels are present together at the time of distribution of the license key, in a distribution server, a terminal device, and a memory card in which a communication counterpart is authenticated by a public key certificate issued by a certificate authority for authenticating each device, key exchange is performed by encrypting a session key which is different in each distribution by using the verified public key, and eventually a license key for decrypting the encrypted contents with the session key is encrypted and then distributed.

### SUMMARY OF THE INVENTION

When a storage device such as a memory card has a function capable of managing a license key, such a function is usually defined as a subset of a data input/output function of the memory card.

When the size of data for transferring the license key such as a certificate and the license key is large, such data occupies a data bus to delay a process based on a normal data input/output instruction.

The present invention is to provide a technology for a storage device and an information processing device operating such a storage device in which, when the size of data used for information transfer such as the license key to be transferred at one time is large, the data is divided and then transferred, thereby allowing an interrupt to the process of transferring information such as the license key.

The present invention is directed to a technology for a system having an information processing device and a storage device which handle digital content data and license information thereof, and has features as follows.

The present invention is directed to a system in which a plurality of types of storage devices can be separately connected to an information processing device via predetermined interfaces, and the storage devices have a license information management function (also referred to as a security function) and the information processing device operates and uses the license information management function of the storage devices. For example, in the system, the information processing device is connected through a network or the like to process digital contents and the license information thereof.

(1) The present invention is directed to a storage device (TRM module 164 of FIG. 1 and a card 240 of FIG. 2) which can be connected to a first information processing device (corresponding to a terminal 100 in FIG. 1), and the storage device includes: a memory (first storage means, which is, for example, a buffer in a controller chip 220 of FIG. 2) for storing externally-provided data; a non-volatile memory (second storage means, which is, for example, a flash memory of a flash memory chip 230 of FIG. 2) for storing the data stored in the memory; a controller (the controller chip 220 and the flash memory chip 230) which controls reading and writing of data from and to the memory and the non-volatile memory; and an interface (I/F) unit with an external device. Also, the storage device stores data associated with license information, and the data is operated and used by the information processing terminal.

When a predetermined process (security process) is externally requested, the controller determines whether the data size of the input data exceeds a data management size based on a data size (a size of the entire data to be subjected to the predetermined process) of the input data contained in a first divided input data (this division is based on a block unit of a predetermined size which can be transferred at one time) of the input data externally provided for the predetermined process (such as the data associated with license information). Then, in accordance with the determination result, the controller sequentially saves, in the non-volatile memory, divided input data of the input data retained in the memory. Then, when receiving an n-th divided input data (for example, a final divided data) of the input data from outside, the controller reads the divided input data saved in the non-volatile memory to the memory. Then, by using the n-th divided input data in the memory and the divided input data read from the non-volatile memory, the predetermined process is performed (for example, FIG. 16A to FIG. 16F).

(2) Also, in the storage device of (1), the controller determines whether the data size of the output data exceeds the data management size based on a data size of output data contained in a first divided output data of the output data to be outputted to the outside as a result of the predetermined process. Then, in accordance with the determination result, the controller sequentially saves divided output data other than the first divided output data of the output data in the non-volatile memory. Then, when saving an m-th divided output data (for example, a final divided data) of the output data in the non-volatile memory, the controller outputs the first divided output data to the outside and/or outputs the divided output data in the non-volatile memory to the outside via the memory (for example, FIG. 17A to FIG. 17E).

(3) Furthermore, in the storage device of (2), in response to a request from outside, the controller outputs the divided output data in the non-volatile memory via the memory, that is, by reading the divided output data to the memory, to the outside.

(4) Still further, in the storage device of any of (1) to (3), the controller allocates a save area in the non-volatile memory for saving the divided input data in accordance with the determination result of whether the data size of the input data exceeds the data management size of the storage device.

(5) Still further, in the storage device of any of (1) to (4), the controller allocates a save area in the non-volatile memory for saving the divided output data in accordance with the determination result of whether the data size of the output data exceeds the data management size of the storage device.

(6) Still further, in the storage device of any of (1) to (5), while the input data for the predetermined process is inputted from outside and stored in the memory, the memory stores input data for another process different from the predetermined process.

(7) Still further, the information processing device connected to the storage device includes: an agent processing unit which controls communication between the information processing device and another information processing device; and an entity processing unit which converts a communication scheme with the agent processing unit to a communication scheme with the storage device in accordance with the type of the storage device. Also, the agent processing unit and the entity processing unit request the controller and the memory of the storage device to perform a predetermined process for the data associated with the license information, and divide and transfer the data for the predetermined process.

Accordingly, in the storage device and the information processing device, for example, when the size of the data for transferring the license key to be transferred at one time is large, the data is divided and then transferred for the process. This allows an interrupt to a process of transferring the license key, thereby achieving efficient processing. For example, the storage device includes: a data processing unit which can be used as a storage for a normal data process; and a security processing unit for performing a security process, and the information processing device causes these two processes to be independently performed. During a data transfer for the security process, an interrupt of a data transfer for the normal data process is caused to suspend the data transfer process for the security process, and after the end of the data transfer for the normal data process, the data transfer process for the security process is resumed.

(8) Still further, the information processing device and the storage device are not restricted to those that can be separately connected. A configuration is also available in which the storage device is integrally formed with the information process device and the function of the storage device as described above is achieved in the information processing device through a software process or the like.

The effects obtained by typical aspects of the present invention will be briefly described below. According to the present invention, in a system having a terminal device and a storage device which handle license information, the storage device can efficiently perform the process even when data associated with the license information such as security data, that is, data for transferring a license key which exceeds a retained memory (data management size) is inputted and outputted collectively or in a divided manner from and to an external terminal.

### BRIEF DESCRIPTIONS OF THE DRAWINGS

FIG. 1 is a drawing of the entire configuration of a system according to one embodiment of the present invention;

FIG. 2 is a drawing of the configuration of a storage device in the system according to one embodiment of the present invention;

FIG. 3 is a flowchart of an authentication process of a license information transfer destination in the system according to one embodiment of the present invention;

FIG. 4 is a flowchart of a transfer process of the license information transfer destination in the system according to one embodiment of the present invention;

FIG. 5 is a flowchart of an authentication process of a license information transfer source in the system according to one embodiment of the present invention;

FIG. 6 is a flowchart of a re-connection process of the license information transfer destination in the system according to one embodiment of the present invention;

FIG. 7 is a flowchart of a re-connection process of the license information transfer source in the system according to one embodiment of the present invention;

FIG. 8 is a flowchart of a read process of the license information transfer source in the system according to one embodiment of the present invention;

FIG. 9 is a drawing of a list of a security function of the storage device in the system according to one embodiment of the present invention;

FIG. 10 is a drawing of an instruction format of the storage device in the system according to one embodiment of the present invention;

FIG. 11 is a flowchart of a process of the security function of the storage device in the system according to one embodiment of the present invention;

FIG. 12 is a flowchart at the time of successive license information transfer in a read process of the license information transfer source in the system according to one embodiment of the present invention;

FIG. 13 is a flowchart at the time of successive license information transfer in a transfer process of the license information transfer destination in the system according to one embodiment of the present invention;

FIG. 14 is a flowchart at the time of successive license information transfer in a transfer process of the license information transfer source in the system according to one embodiment of the present invention;

FIG. 15 is a flowchart of a transfer process of the license information transfer source in the system according to one embodiment of the present invention;

FIG. 16A is an explanatory drawing of a procedure of inputting data in a divided manner in the storage device in the system according to one embodiment of the present invention;

FIG. 16B is an explanatory drawing of a procedure of inputting data in a divided manner in the storage device in the system according to one embodiment of the present invention;

FIG. 16C is an explanatory drawing of a procedure of inputting data in a divided manner in the storage device in the system according to one embodiment of the present invention;

FIG. 16D is an explanatory drawing of a procedure of inputting data in a divided manner in the storage device in the system according to one embodiment of the present invention;

FIG. 16E is an explanatory drawing of a procedure of inputting data in a divided manner in the storage device in the system according to one embodiment of the present invention;

FIG. 16F is an explanatory drawing of a procedure of inputting data in a divided manner in the storage device in the system according to one embodiment of the present invention;

FIG. 17A is an explanatory drawing of a procedure of outputting data in a divided manner from the storage device in the system according to one embodiment of the present invention;

FIG. 17B is an explanatory drawing of a procedure of outputting data in a divided manner from the storage device in the system according to one embodiment of the present invention;

FIG. 17C is an explanatory drawing of a procedure of outputting data in a divided manner from the storage device in the system according to one embodiment of the present invention;

FIG. 17D is an explanatory drawing of a procedure of outputting data in a divided manner from the storage device in the system according to one embodiment of the present invention;

FIG. 17E is an explanatory drawing of a procedure of outputting data in a divided manner from the storage device in the system according to one embodiment of the present invention;

FIG. 18A is a flowchart of a procedure of reading and writing license information in the system according to one embodiment of the present invention; and

FIG. 18B is a flowchart of a procedure of reading and writing license information in the system according to one embodiment of the present invention.

### DESCRIPTIONS OF THE PREFERRED EMBODIMENTS

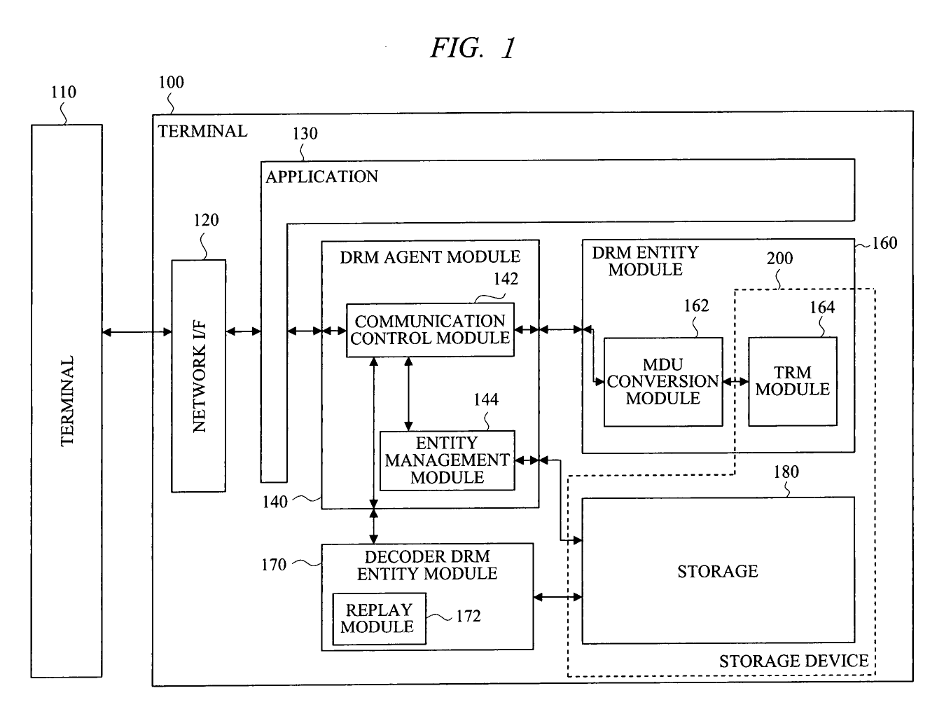

Hereinafter, embodiments of the present invention will be described in detail with reference to the accompanying drawings. Note that components having the same function are denoted by the same reference symbols throughout the drawings for describing the embodiment, and the repetitive description thereof will be omitted. Note that FIG. 1 to FIG. 18 are drawings for describing the embodiments of the present invention.

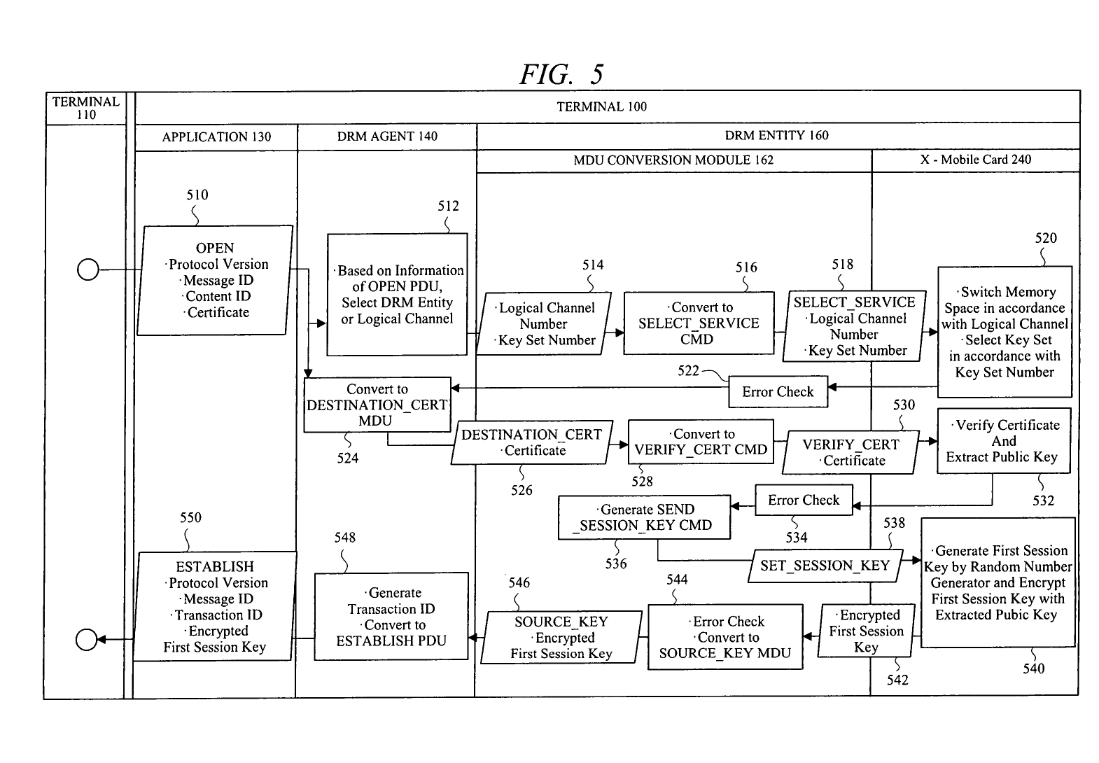

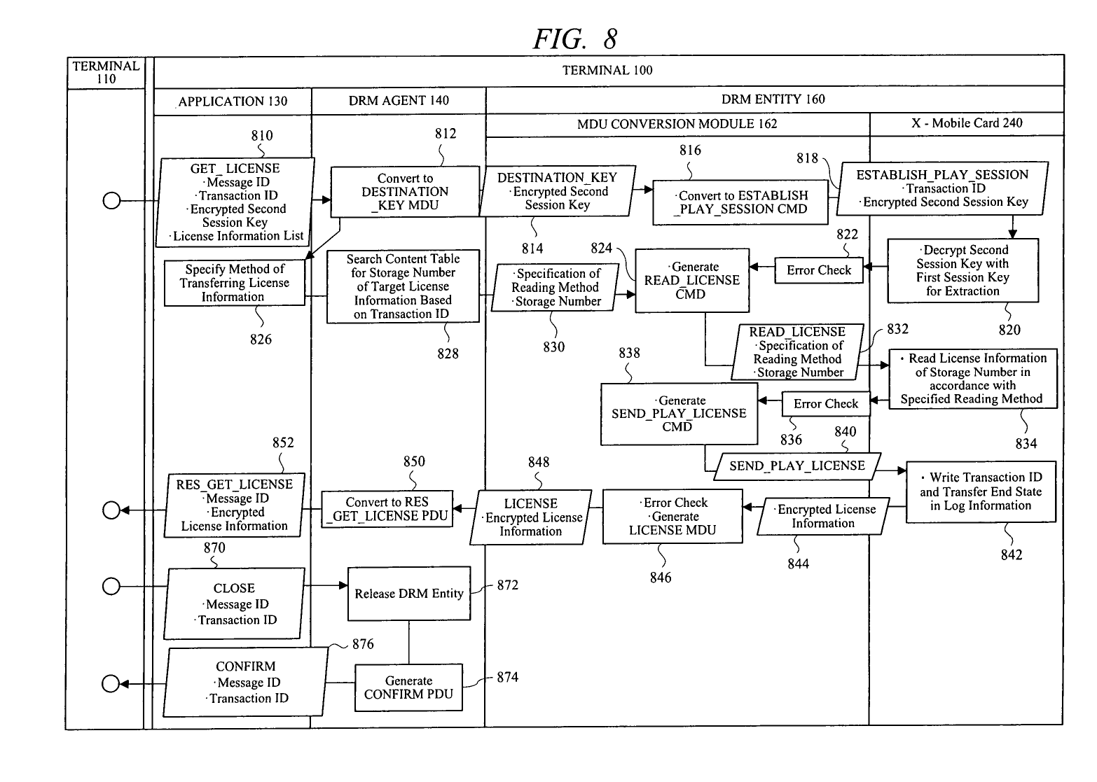

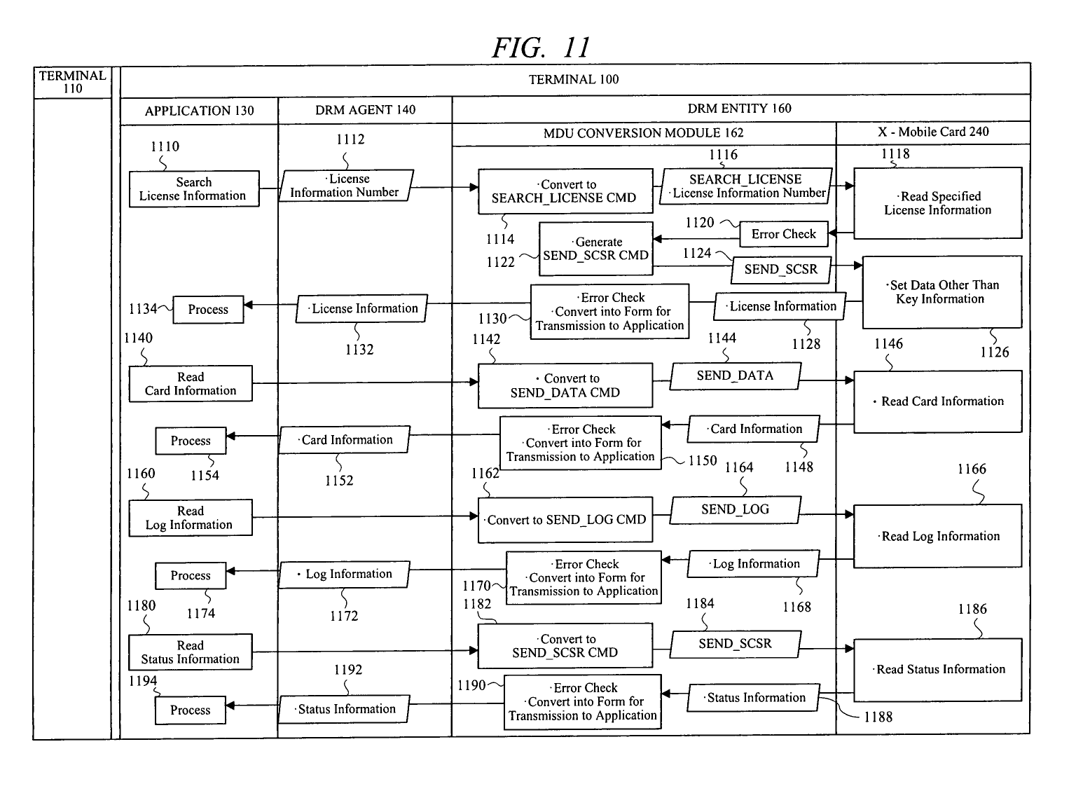

In this embodiment, as specifications of a system including a terminal and a storage device connected thereto or incorporated therein, a command I/F which uses the storage device to achieve a DRM function is defined. The terminal issues a command to the storage device to cause the storage device to perform a process, thereby achieving a license information processing function. In particular, data or information transferred from the storage device to the terminal includes status information for managing a state of a DRM sequence (transaction state). Also, a command I/F for transferring a plurality of pieces of license information is also defined. The terminal uses a processing function of the storage device (in particular, shown in FIG. 11, FIG. 5, and FIG. 8), thereby achieving a license information management function.

FIG. 1 is a drawing of the configuration of a system according to the present embodiment. This system is composed of a terminal (information processing device) 100 and a terminal (information processing device) 110 which is a communication counterpart. Hereinafter, the terminal 100 is referred to as a first terminal 100, and the terminal 110 is referred to as a second terminal 110 for convenience. The system is provided with a license information processing function in accordance with a predetermined DRM system, and as conceptual modules for that function, the system includes a DRM agent (140) and a DRM entity (160). In each terminal (100, 110), these modules are implemented by predetermined hardware and software. The implementing scheme thereof is not restrictive.

Here, the first terminal 100 and the second terminal 110 are assumed to be of the same type of devices having the same configuration. That is, the second terminal 110 has the DRM agent, the DRM entity, and others similar to the first terminal 100. The first terminal 100 and the second terminal 110 may have different hardware implementation configurations. Such terminals (100, 110) correspond to various types of devices such as a server device, a PC, a HDD-equipped video receiver, a vehicle-equipped information processing device, a portable phone, and a portable moving-picture player.

The terminal 100 includes a network I/F 120, an application 130, a DRM agent module (hereinafter also referred to as a DRM agent) 140, a DRM entity module (hereinafter also referred to as a DRM entity) 160, a decoder DRM entity module (hereinafter also referred to as a decoder DRM entity) 170, and a storage 180.

The network I/F 120 is used for data input/output with the outside (for example, a network). The application 130 operates the network I/F 120 and the DRM agent module 140 based on the instruction from a user or an operation of the device. The DRM agent module 140 includes a communication control module 142 and an entity management module 144, and it controls the operation of the DRM entity module 160. The DRM entity module 160 includes an MDU conversion module 162 and a TRM (tamper-resistant) module 164, and it manages license information. The license information is stored in the TRM module 164. The decoder DRM entity 170 includes a replay module 172, and it uses the license information stored in the DRM entity module 160 to operate content data in the storage 180. The storage 180 stores content data such as music. In the present embodiment, it is assumed that content data to be protected is music data, and this music data is replayed in the replay module 172.

In each terminal (100, 110), a storage device 200 is connected or incorporated. In the present embodiment, the storage device 200 of the terminal 100 corresponds to the TRM module 164 and the storage 180, and it is detachably connected to the terminal 100.

Note that, if information exchanged between the terminals (100, 110) is equivalent in an input/output unit (including the network I/F 120) of each of the terminals, one or more other devices such as terminals may be inserted between the terminals. More specifically, a terminal (intermediate terminal) for intermediacy or relay between the terminals may be interposed, for example. Here, other terminals described above correspond to a parser for converting a data format, a base station or an access point for switching a communication network, a router for switching a communication path, a server for managing communications, and others. What “the information is equivalent in the input/output unit” means that the information can be converted in accordance with a predetermined format irrespective of a description format of information such as text data, binary data, and others, and as a result, the type of the information, the data size of the information and the information itself can be sufficiently transmitted. Therefore, even if the intermediate terminal performs operations such as IP address conversion, data encryption, or scrambling, the presence of the intermediate terminal does not pose any problem as long as the information exchanged between the terminals is equivalent in the input/output unit of each terminal.

The network I/F 120 is not restricted to a LAN, a wireless LAN, and the Internet, but may be an I/F for connecting a PC and its peripherals to a device such as USB, IEEE 1394, Bluetooth, and IDE.

The application 130 is a module which makes a purchase of license information, uses a content by using the license information, and moves the license information to another terminal. On the application 130, services associated with acquisition of the license information are performed. The application 130 can be implemented as not only single software but a combination of a plurality of pieces of software with different functions. Also, the application 130 retains information shared with the application (130) of the other terminal (110) (for example, information such as a public key or a session key for authentication) in order to protect the communication with other terminal (110), and information exchanged between the terminals (100, 110) can be encrypted by using this shared information.

The DRM agent module 140 can be implemented as a part of the application 130 or can be implemented as another module. If the DRM agent module 140 is implemented as another module, the application 130 can switch the DRM agent modules 140 prepared for respective services to use the DRM agent module 140 suitable for the service. Therefore, an effect of improving mutual operability can be achieved.

Also, the communication control module 142 has a data conversion function, a connection function, and a function to control the operation of the DRM agent module 160 by the application 130. By the data conversion function, data transmitted from the second terminal 110 is converted to a format which can be interpreted in the DRM entity module 160 and data received from the DRM entity module 160 is converted to a format which can be interpreted in the second terminal 110. Also, by the connection function, the second terminal 110 and the DRM entity module 160 are connected, the DRM entity module 160 and the decoder DRM entity module 170 are connected, and the decoder DRM entity module 170 and the second terminal 110 are connected.

Furthermore, the entity management module 144 has a function to store a protected content in the storage 180 together with content related information such as content identification information, music name, replay time, and bit rate and a function to read the content from the storage 180 by using the content identification information.

The decoder DRM entity module 170 is a module for replaying music data which is the protected content, and it has a function to read license information from the TRM module 164 in the DRM entity module 160 by using the replay module 172, and make a protected content (music data) in the storage 180 available by using the license information.

Here, the operation of making the protected content available corresponds to an operation of decrypting an encrypted content with an encryption key (secret key) included in the license information and converting the decrypted content to a processable content format such as MPEG, MP3, JPEG, ZIP, or a document included in the decoder DRM entity 170. Note that MPEG is an abbreviation of Moving Picture Expert Group, MP3 is an abbreviation of MPEG Audio Layer 3, and JPEG is an abbreviation of Joint Photographic Expert Group, which are standard encoding formats standardized under ISO/IEC JTC1/SC29. Also, ZIP is one of file compression formats.

The decoder DRM entity 170 can be implemented by hardware which is more difficult to interpret than software in order to improve the tamper resistant, and it can be implemented in a device such as another terminal connected to the terminal 100. In this case, another terminal described above corresponds to, for example, a speaker, a headphone, an amplifier, or a television set. Also, when the decoder DRM entity 170 transfers license information of another DRM system, the decoder DRM entity 170 may have a DRM conversion module.

The DRM entity module 160 (in particular, the TRM module 164) can be implemented by a combination of a non-volatile storage area such as a flash memory, EEPROM, or HDD in the terminal and software, but may be an external device having a function corresponding to this combination. Examples of such an external device include X-Mobile Card (X-Mobile Card is a product by Renesas Technology Corp.), SD memory card (SD is an abbreviation of Secure Digital), Memory Stick (Memory Stick is a registered trademark of Sony Corporation), USB memory with a security function, HDD with a security function, and IC card.

However, the MDU conversion module 162 in the DRM entity module 160 has a function to convert input data from the DRM agent module 140 (in particular, the communication control module 142) to a format which can be interpreted in the TRM module 164 in accordance with an input/output format (I/F) for each device (storage device 200) and convert output data from the TRM module 164 to a format which can be interpreted in the DRM agent module 140 (in particular, the communication control module 142). The MDU conversion module 162 can be present in the terminal when the DRM entity module 160 is formed as an external device. In the present embodiment, the TRM module 164 is implemented in the storage device 200 which is an external device of the terminal 100, and the MDU conversion module 162 is present in the terminal 100. By adopting the configuration in which the MDU conversion module 162 is left in the terminal, such an effect that the TRM module 164 can be easily replaced irrespective of a difference in input/output I/F of storage devices 200 can be achieved. Also, in place of the non-volatile storage device, a combination of a volatile storage device such as SRAM or DRAM and a battery-type power supply device can be used. In this case, it is possible to set an expiration time based on the life of the battery to the license information stored in the TRM module 164. Furthermore, the structure in which the expiration time of the license information can be updated by additionally supplying power to the battery-type power supply device through authentication is also preferable.

In the conventional DRM system, the system configuration to be implemented is limited to either of the configuration where a function corresponding to the DRM agent and a function corresponding to the DRM entity do not have to be separated (that is, these functions are integrated) or the configuration where these functions are defined as specifications. However, in the DRM system where the function corresponding to the DRM agent and the function corresponding to the DRM entity are logically defined, a mechanism of connecting the DRM agent and the DRM entity remains as a problem. Here, by defining a mechanism for operating the DRM entity, the system can be uniformly handled even if it has the configuration where the DRM agent and the DRM entity are integrated or the configuration where they can be separated as devices. Therefore, an effect of improving flexibility of system configuration can be achieved.

The present embodiment defines a function to notify the DRM agent (140) of the function or performance of the DRM entity (160), an operation for authenticating another terminal (110) by using the DRM entity (160), an operation for exchanging a session key with another device (110) by using the DRM entity (160), an operation for acquiring or providing license information by using the DRM entity (160), an operation for acquiring the state of the DRM entity (160), and an operation for acquiring the state of the license information in the DRM entity (160). That is, an object of the present embodiment is to achieve the common operations of the DRM entity (160) from the application (130) or the DRM agent (140).

Also, in the operations defined herein, if inputs and outputs are performed in units of data in the storage device (200) when the relevant DRM entity (160) writes data in the storage device (200), a necessary buffer size can be reduced and the performance can be improved. Therefore, the present embodiment also mentions a mechanism for adjusting the size of data to be transmitted or received when operating the DRM entity (160), thereby reducing the necessary buffer size and improving the performance. Furthermore, an input/output format when one or plurality of TRM modules (164) are accessed by a plurality of DRM agent modules (140) is also defined.

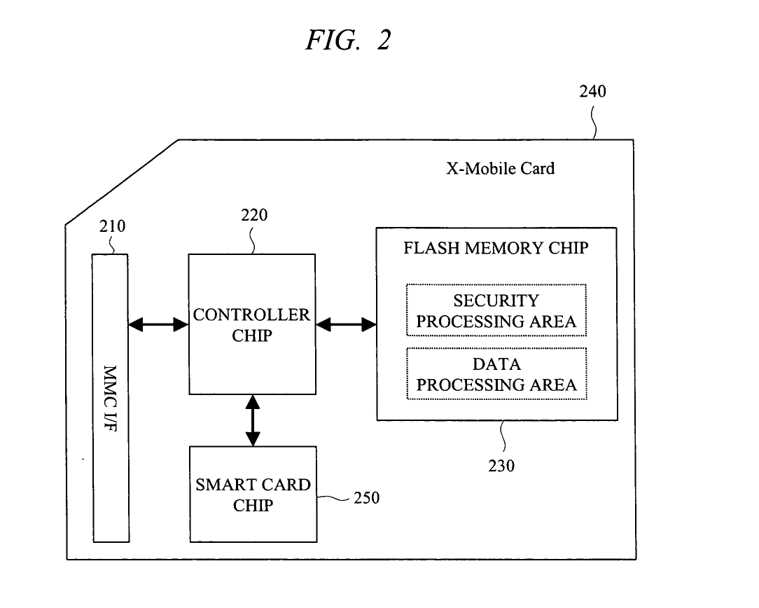

FIG. 11 depicts operations of each of the modules and components in a more detailed embodiment where the TRM module 164 of the DRM entity 160 is achieved by a function of the storage device 200 which is detachably connected to the terminal 100, in a system configuration including the application 130, the DRM agent 140, and the DRM entity 160 as shown in FIG. 1. In the present embodiment, the storage device 200 is replaced with an X-Mobile Card (hereinafter abbreviated as a card) 240 having the configuration shown in FIG. 2. The card 240 is a storage device having processing functions including a license information management function. In the present embodiment, not only the TRM module 164 but also the storage 180 are implemented as functions of the card 240.

In FIG. 2, the card 240 has a configuration including an MMC /IF (MultiMedia Card interface) 210, a controller chip 220, a flash memory chip 230, and a smart card chip 250. The MMC I/F 210, the flash memory chip 230, and the smart card chip 250 are connected to the controller chip 220 for main control, and the controller chip 220 for main control is connected to the outside (that is, the terminal 100) through the MMC I/F 210.

The MMC I/F 210 interfaces reception of data and commands with the outside. The MMC is an abbreviation of MultiMedia Card, and is a registered trademark of Infineon Technology AG. The controller chip 220 interprets a command from the outside, and it controls reading and writing of data from and to the flash memory chip 230 and the smart card chip 250. The flash memory chip 230 stores data such as license information. The smart card chip 250 performs processes for authenticating individuals and others. In the present embodiment, however, the functions of the smart card chip 250 are not used, and the controller chip 220 and the flash memory chip 230 perform such processes.

The card 240 includes a security processing unit and area inaccessible from the host (that is, the terminal 100), in which process data is protected, and a relatively-high-speed data processing unit and area accessible from the host. For example, the flash memory chip 230 includes a tamer-resistant storage area corresponding to the security processing unit and a storage area corresponding to the data processing unit, which correspond to the TRM module 164 and the storage 180, respectively.

The controller chip 220 includes data processing units associated with a license information process, controls and performs the process, and has a storage area to be a buffer for the process. Data can be inputted and outputted between the buffer area and the areas in the flash memory chip 230.

In the configuration where the DRM agent 140 and the DRM entity 160 can be separated, that is, they can be detachably connected as different devices, the DRM agent 140 may perform an operation of checking the configuration of the DRM entity 160 when the DRM entity 160 is connected. With this operation, even if the function and performance of the DRM entity 160 vary, processes in accordance with the variance in function and performance can be performed. If it is known that no variance is present in function and performance of the DRM entity 160 or the variance poses no problem, in the case where the variance in function and performance is unique to the I/F format, for example, it is not always necessary to check the configuration of the DRM entity 160. This function is implemented by a card information reading function (1140) in FIG. 11.

When the card information reading function (1140) is performed in the terminal 100, its instruction is converted by the MDU conversion module 162 to SEND_DATA_CMD 1144 (process 1142). Note that CMD is an abbreviation of a command (instruction). SEND_DATA_CMD 1144 is an instruction to the card 240, by which card information (device information) stored in the card 240 is outputted. As described above, the instruction defined as CMD is an instruction set unique to the card 240. When the TRM module 164 (that is, the storage device 200) other than the card 240 is used, the instruction name, data format, transfer data size, and others may vary, as long as the data inputted to and outputted from the inside of the TRM module 164 is equivalent and the TRM module 164 has an equivalent processing function. At this time, the MDU conversion module 162 performs a function to convert an instruction in an MDU format sent from the DRM agent module 140 or an instruction executed by the application 130 in accordance with an implementation format of the relevant TRM module 164. With this function, such an effect that, for the instruction in the MDU format, the DRM entity module 160 can be handled equally to another implementation scheme irrespective of an implementation scheme of the TRM module 164 can be achieved. The same goes for all CMDs described below. Here, the MDU is an abbreviation of a Message Data Unit, and it means data passed from the DRM agent to the DRM entity.

When the card 240 receives SEND_DATA CMD 1144, the card 240 may return card information previously stored in the card 240 (process 1446). The card information may include an issuer's name, card ID, user ID, type of command available, type of communication protocol available, type of encryption algorithm available, type of license information available, and profile identification information and version. Also, the description format of these pieces of information may be defined for each service. For example, if the available command type, communication protocol type, encryption algorithm type, and license information type can be identified with the profile identification information and version, these pieces of information may not be described in the card. Also, if only one profile identification information and version can be taken in the relevant implementation format, only the card ID information may be sent. Furthermore, if user identification is not required, the user ID may not be included. Still further, information outputted in status information reading 1180 for outputting the state of the card may include card information.

The card information 1148 outputted from the card 240 is converted by the MDU conversion module 162 to card information 1152 (process 1150), and is then processed by the application 130 (process 1154). In this case, the process 1154 handled by the application 130 includes the function check of the connected TRM module 164. By reporting the function of the TRM module 164 to the communication counterpart device (110) when the application 130 is connected to anther terminal (110) for communication, the communication destination (110) can determine whether it has a sufficient function for transferring license information. Also, when there are a plurality of types of protocol and encryption algorithms available, the communication destination (110) can select a scheme conforming to transfer requirements of the license information from them, and transfer the information to the communication counterpart (100) by using the selected scheme.

Also, the application 130 can perform a process of searching the license information 1110, a process of reading log information 1160, and a process of reading status information 1180 in an arbitrary order. The application 130 is required to accurately know the state of the connected card 240, and therefore, it is preferable to perform these processes at arbitrary intervals.

The process of searching the license information 1110 corresponds to a process of reading identification information, license information, limitation information of the license information except secret information such as a key used in encrypting the content from the license information stored in the card 240. In this process, a license information number 1112 corresponds to, for example, an address in a license information storage area stored in the card 240. The license information except the secret information is preferably stored in the storage area in the terminal 100 or the storage area in the card 240. This is because, in the area with access limitations for security in the storage device 200 (which corresponds to the area of the TRM module 164), an access speed is lower than that of a storage area which can be directly operated by the terminal 100, and information is not retained so that the terminal 100 can easily manage the information. For this reason, by storing the license information except the secret information in an easily-accessible storage area, for example, the storage 180 in the card 240, such effects that the information can be easily accessed and a search speed can be increased can be achieved.

However, there is a problem that, when the license information is tampered with or corrupted, the target license information cannot be accurately found. If the application 130 can use the process of searching the license information 1110 at arbitrary intervals for the purpose of finding tampering and corruption of the license information and repairing such tampering and corruption of the license information, such an effect that an improvement in accessibility and ensured data completeness can both be attained can be achieved. Therefore, based on the identification information included in the content and the identification information of the read license information, the DRM agent 140 or the application 130 can repair the relation therebetween. For this purpose, the content and the license information preferably include correlated identification information. An example of such identification information is content identification number (content ID).

If the DRM entity module 160 has a file system when receiving the license information number 1112, the license information number 1112 may be converted to a combination of information representing a level in a relevant hierarchical directory configuration and information regarding an element position in the directory by the MDU conversion module 162 (process 1114), and then may be sent to the card 240 as SEARCH_LICENSE_CMD 1116. Also, if the DRM entity module 160 includes a plurality of license information storage areas each with a fixed length, the license information number 1112 may be converted by the MDU conversion module 162 to an address of the license information storage area, and then may be sent to the card 240 as SEARCH_LICENSE_CMD 1116. In this case, the license information number represents information based on the number of stored licenses acquired by the process of reading the card information 1140 or the process of reading the status information 1180. The number of stored licenses represents a value which is calculated from the capacitance of each license with respect to the area for license information storage allocated in the card 240 and is defined at the time of issuing the card. This value does not have to be a maximum number that can be stored, but may be an arbitrary value smaller than the maximum number. SEARCH_LICENSE_CMD 1116 is processed in the card 240. When the license information is present in a specified place, the card 240 can cause the license information to be in an output-enable state (process 1118).

The MDU conversion module 162 checks an error when receiving a process completion notification from the card 240 (process 1120). Here, an error outputted from the card 240 may be in a description format unique to the card 240. After checking an error, when the check result is returned to the application 130 or the DRM agent 140, the check result can be converted to error code which can be recognized by the application 130 or the DRM agent 140. The error code to be passed herein does not have to conform to unified standards because the application 130 or the DRM agent 140 can know the type of function supporting the card 240 from the process of reading the card information 1140, and if the card 240 is supported based on this information, the error code of the card 240 can be recognized. That is, the MDU conversion module 162 can interpret the error code in accordance with the type of the connected TRM module 164, and therefore, even if a scheme of converting the error code to a format which can be recognized by the application 130 or the DRM agent module 140 depends on implementation, the scheme poses no problem in mutual operability. This process is common to an error check process which will be described further below. If there is no error, the MDU conversion module 162 generates SEND_SCSR CMD for extracting license information (process 1122). The generated SEND_SCSR CMD 1124 is inputted to the card 240. When the card 240 receives the SEND_SCSR CMD 1124, it sends the license information (summary) in an output-enable state in conjunction with the status information to the MDU conversion module 162 (process 1126). The MDU conversion module 162 performs processes such as error check and format conversion to the information outputted from the card 240 (process 1130), and then returns the process result to the application 130 as the license information 1132. Based on the license information 1132, the application 130 performs processes such as tampering detection and recovery of the license information on the storage (process 1134). Here, when the TRM module 164 includes an instruction system allowing bidirectional input/output with one instruction, as the processing result of the process 1118, the error information and the license information can be outputted as a result of the input of SEARCH_LICENSE CMD 1116.

The process of reading the log information 1160 corresponds to a process of reading information regarding the state of a transaction being processed from the information stored in the card 240. The state of the transaction includes transaction identification information, information regarding the state of execution of the transaction, and the state of the license information. In this case, a transaction is a unit of transfer of the license information, and the transaction identification information is identification information for each piece of distributed license information prepared in the form corresponding to the identification information of the content specified from the communication destination to the communication source. Also, the information regarding the state of execution of the transaction represents whether the transaction is being executed or ended, and the state of the license information is the information to check whether the license information has been accurately stored. This information can be used to determine whether the transaction is to be reconnected when a power supply interrupt or the like occurs during the execution of the transaction and to check that the license information has been stored after the end of the transaction. However, this function may not be implemented if no protocol for reconnecting the transaction is implemented. Meanwhile, this function is preferably implemented if there is the possibility that the DRM agent module 140 is connected to the DRM agent having a transaction reconnection function. The presence of the transaction reconnection function can be checked through the process of reading the card information 1140.

An instruction for the process of reading the log information 1160 is converted to SEND_LOG CMD 1164 by the MDU conversion module 162 (process 1162), and is then processed in the card 240 (process 1166). This process corresponds to, for example, an operation of extracting information regarding the state of the transaction from the transaction information stored in the card 240 and outputting the extracted information. The card 240 contains key information for encrypting data being communicated and information about previous transactions in addition to the information regarding the state of the transaction to be outputted. However, outputting the key information for data encryption should be prohibited because such an output will allow tapping of information in a session. Also, the information about previous transactions do not have to be outputted, but may be outputted if the TRM module 164 has a function to reconnect a previous transaction. Log information 1168 outputted from the card 240 is converted by the MDU conversion module 162 to log information 1172 based on the result of checking the presence of an error (process 1170), and is then processed by the application (process 1174). The process 1174 corresponds to, for example, a process of determining whether a retransmission process is necessary and a process of checking the completion of the transaction.

The process of reading the status information 1180 corresponds to a process of reading identification information of the DRM entity module 160, a maximum number of pieces of stored license information, error state, state of the protocol, a key information set for use, the state of issuance of the card, and others from the information stored in the card 240. In this case, the identification information of the DRM entity module 160 corresponds to, for example, information representing a type or version of license information protection system (DRM system). The error state represents an error occurring in the card 240, and the state of the protocol means the state of the card making a transition in response to an instruction inputted to the card. In the DRM entity module 160, an acceptable instruction may be determined depending on the state, and when an instruction other than the acceptable instruction is inputted, the process can be ended.

If the DRM agent and the DRM entity are detachably connected to each other, there is a possibility that the DRM agent and the DRM entity are connected in the manner of not only a one-to-one connection, but also one-to-many, many-to-one, or many-to-many connection. In such a situation, the DRM agent keeps track of the state of the connected DRM entity (entities), thereby achieving an effect of improving the synchronism with the state of the DRM entity.

In the conventional system, even when the state of the system in the terminal does not match with the state of a connected security processing device, the DRM agent does not have means for checking the state of a security process of the DRM entity. Therefore, if the DRM agent issues an instruction and synchronization cannot be completed, the error code returned from the DRM entity is the only way to check whether an instruction is to be issued or not. However, if a plurality of DRM agents access one DRM entity in a state of many-to-one connection, scheduling of instructions inputted to the DRM entity is desired in some cases. At this time, if the DRM agent can always check the synchronization with the state of the DRM entity, such an effect that re-scheduling is easily performed at the time of occurrence of an error in a DRM agent can be achieved. A reason for this is as follows. In a protocol for protecting the license information, commands have to be issued in a predetermined order, but the timing of issuing each command varies depending on the state due to the processing time of the communication destination. Since the DRM entity does not perform a process in a period between the times of issuing commands, if the DRM entity is caused to perform another process in that period, an improvement in process efficiency can be expected.

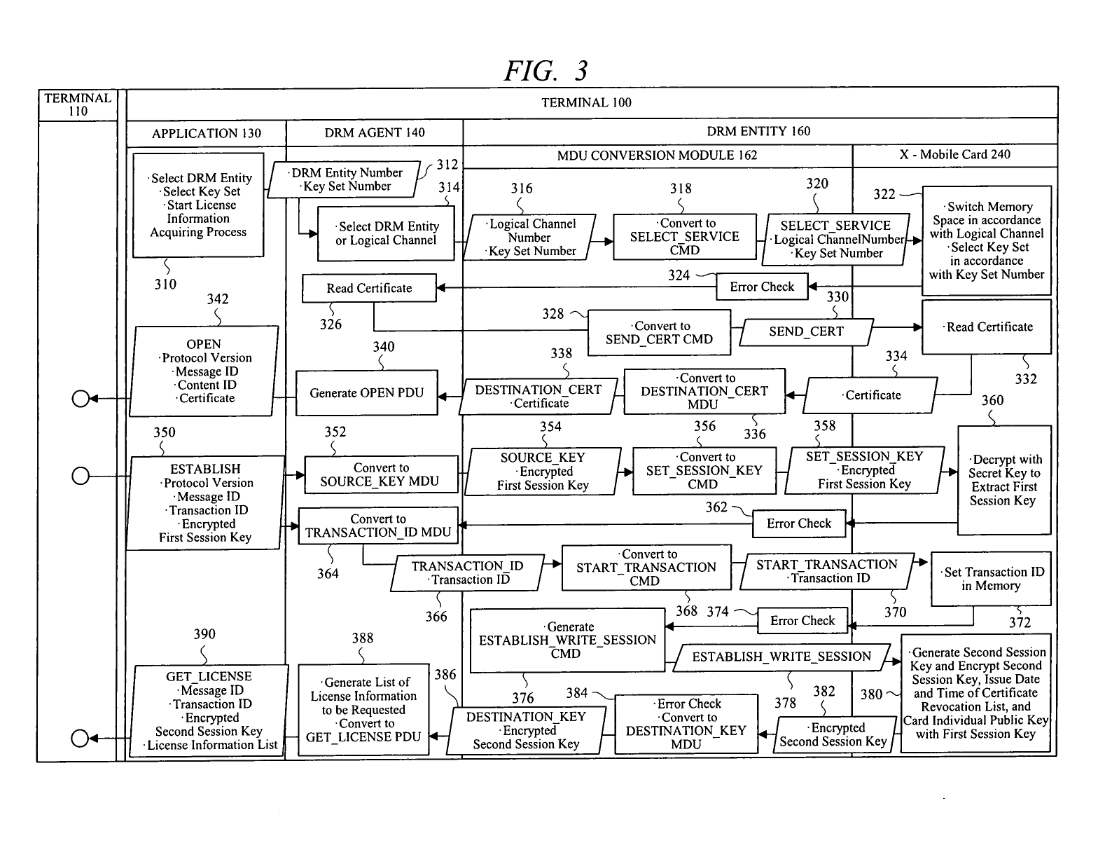

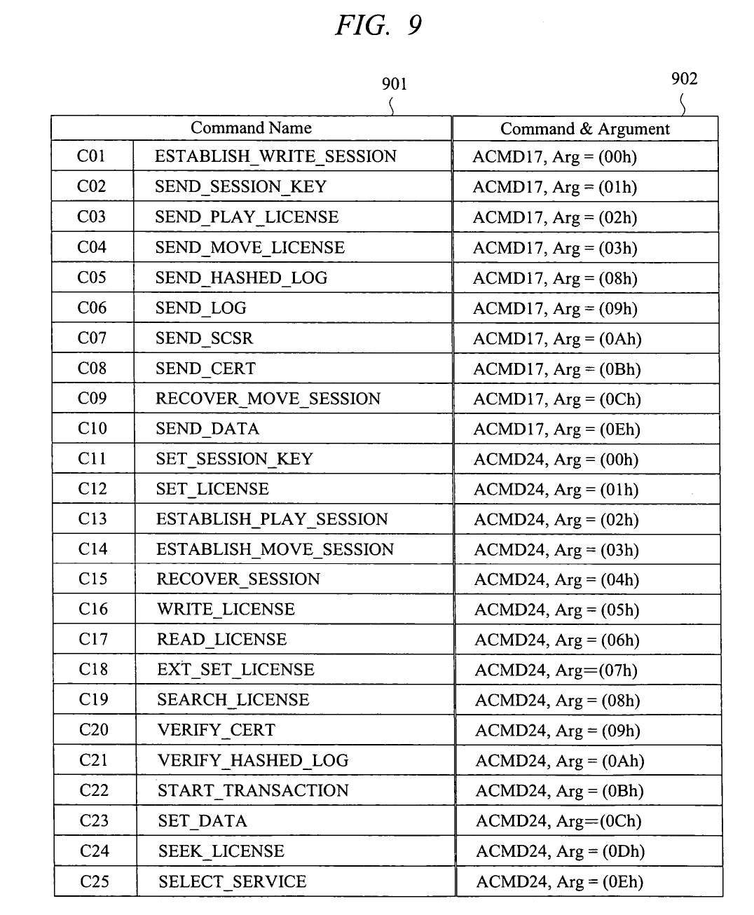

The plurality of DRM agents connected to the DRM entity issue instructions in accordance with the type of protocol specified by the application. Therefore, it is possible to adjust the order of instructions to be issued so that a latency time is decreased. In the case of authentication through public key cryptography, the key information set for use corresponds to a public key certificate prepared for each service, its corresponding secret key, a public key or public key certificate of a certificate issuer for verifying the pubic key certificate, and a certificate revocation list issued by the certificate issuer, for example. In the case of authentication through common key cryptography, the key information set for use corresponds to, for example, secret information for generating a common key from exchanged challenge data, a secret key for protecting the challenge data, and unique identification information allocated to the DRM entity. In the case where these pieces of information vary in accordance with the service or the target device and the DRM entity has a plurality of sets of key information, the DRM agent may be able to check which set of key information is currently used. The DRM entity can specify the type of key set for use through SELECT_SERVICE CMD (C25 of FIG. 9). However, if the key set to be actually used is different from SELECT_SERVICE CMD, the DRM entity can check the actually used key set to reflect the check result onto the type of key set of the status information, thereby performing a process without returning an error. With this process, SELECT_SERVICE itself may be omitted. The behavior of this process will be described in detail further below with reference to FIG. 5 and FIG. 3.

The state of issuance of the card is information for determining whether the card (240) is in a state immediately after manufacturing where no secret information has been written or in an available state where secret information has been written. In the state of issuance of the card, when a secret key has been written and the card is about to be delivered to user's hands, there may be the case where an instruction for writing secret information itself is desired to be prohibited. Therefore, the state of issuance of the DRM entity is outputted as status information, thereby allowing the DRM agent to select an instruction set for use. As a result, it is possible to achieve an effect of eliminating a necessity of inputting an instruction and then checking whether the instruction is used based on an output of error code.

An instruction for the process of reading the status information 1180 is converted by the MDU conversion module 162 to SEND_SCSR CMD 1184 (process 1182), and is then inputted to the card 240 and processed therein (process 1186). The process 1186 corresponds to a process of configuring and outputting status information from the information present on the memory in the card 240. The outputted status information 1188 is converted by the MDU conversion module 162 to status information 1192 in accordance with error check (process 1190), and is then processed by the application 130 (process 1194). Here, the process 1194 corresponds to, for example, a process of stopping a protocol process or a process of synchronizing the state of the protocol. In each CMD process of the card 240, when specifications are such that each CMD of the card 240 does not return detailed error information as a response, the MDU conversion module 162 generates SEND_SCSR CMD for acquiring error information, inputs it to the card 240, and then acquires the error code. The same may go for all CMD processes described below.

If a module which can be separated such as the DRM entity (160) for managing the license information is present, the module has the configuration in which a series of process functions from authentication to key exchange and transfer of the license information are allocated to an instruction set in accordance with the TRM module (164). In this situation, between the DRM agents which communicate with another terminal, manage the content, and operate the DRM entity and the DRM entity, it is possible to acquire sufficient information for connection by using the functions to search the license information 1110, read the card information 1140, read the log information 1160, and read the status information 1180. Also, by providing the MDU conversion module 162 which converts information in accordance with the I/F and a license information protection scheme to be supported in order to connect the TRM module 164 which is a main body of the DRM entity module 160 and the DRM agent module 140, the DRM agent module 140 and the DRM entity module 160 can be easily connected irrespective of the implementation scheme of the DRM entity module 160. Also, three processes of the DRM entity, that is, authentication, key exchange, and transfer of the license information may be divided into two processes, that is, authentication and key exchange, and transfer of the license information. With such a division into two, a plurality of key exchanges can be performed with one authentication, and the license information can be repeatedly transferred. Since the authentication process accounts for a time required for calculation in the protocol process, when a plurality of pieces of license information are acquired or transmitted at one time, the above division can achieve an effect of reducing the processing time. Also, by performing the authentication process not in a manner of one-to-one connection but in a manner of one-to-many, many-to-one, or many-to-many connection, a domain independent from other networks in view of security can be established, and it is possible to achieve an effect of extending the range of the process of transferring the license information. Such an effect includes, in the case where a plurality of license information transfer destinations are present in the domain, an improvement in performance of license information transfer in the domain by acquiring the license information from a device with a small process load.

When the function composed of the processes of authentication of the DRM entity, key exchange, and transfer of the license information is studied based on the specification of UDAC v2, the authentication process can be represented as a process corresponding to a combination of OPEN PDU and ESTABLISH PDU, key exchange can be represented as a process corresponding to GET_LICENSE PDU, and transfer of the license information can be represented as a process corresponding to RES_GET_LICENSE PDU. Here, although the main function of the DRM agent module 140 includes management of the DRM entity module 160 based on the common specifications, communication with another DRM agent with the common functions, and management of content information configured based on the common specifications, it is also possible to adopt the configuration in which the application 130 operates the DRM agent module 140 based on different specifications. At this time, a module which controls the operation of a replay application and a plurality of DRM agents can commonly handle the DRM system by processing in units of authentication, key exchange, and transfer of the license information.

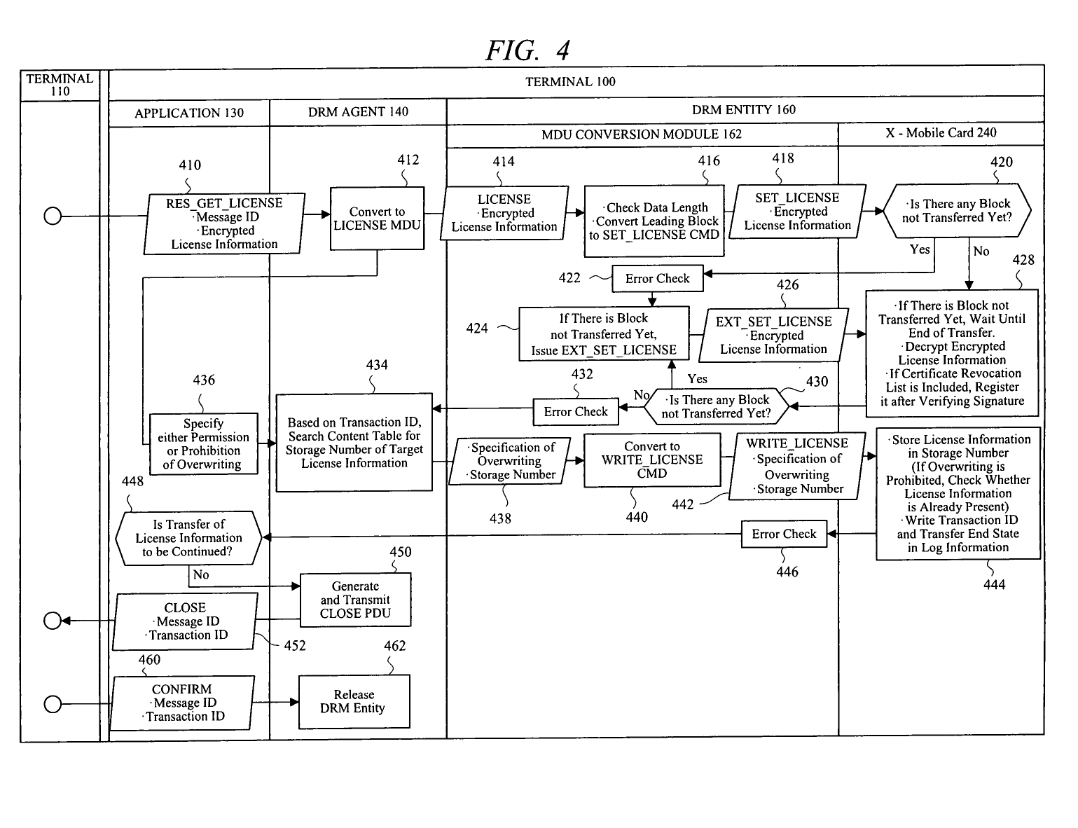

FIG. 3 and FIG. 4 depict a process flow in the case where the terminal (100) acquires license information from another connected terminal (110) in this system. In this case, as a more detailed embodiment, in an implementation structure corresponding to the system shown in FIG. 1 in which UDAC v2 is used as a DRM system and the card 240 is used as the storage device 200 including the TRM module 164 and the storage 180, the operation of acquiring license information will be described, in which a license information encryption key of AES (Advanced Encryption Standard) is shared through certificate authentication based on the public key cryptography and the license information is acquired by using the license information key.

UDAC v2 is an abbreviation of Universal Distribution with Access Control version 2. UDAC v2 is a technical standard for content distribution copyrighted by Hitachi, Ltd., PFU Limited, Renesas Technology Corp., Columbia Music Entertainment, Inc., SANYO Electric., Ltd., and FUJITSU LIMITED. UDAC v2 technological specifications describe a communication protocol between tamper-resistant DRM entities having a license information management function, a communication protocol between DRM agents which control network communication and support communication between DRM entities, specifications regarding requirements of the DRM entity and the DRM agent, and specifications regarding a description format of the license information controlled by the DRM entity.

In FIG. 3, when the application 130 is connected to the terminal 110 which is a server for distributing license information, the application 130 acquires information about a key set effective in a relevant service, and then selects a certificate to be sent to the server and a function of the DRM entity for the DRM agent module 140 (process 310). When the DRM agent module 140 receives a DRM entity number and a key set number (data 312) from the application 130, the DRM agent module 140 selects a DRM entity for use based on the data 312 when there are a plurality of DRM entity modules 160. The DRM agent module 140 can convert the data 312 in accordance with the type of the TRM module 164 connected to the MDU conversion module 162 in the selected DRM entity module 160 (process 314). This process corresponds to, for example, a process of converting the DRM entity number to a logical channel number when the DRM entity module 160 has a function which makes it possible to simultaneously perform a plurality of processes such as logical channels. Also, if the TRM module 164 has a different key or algorithm service for each service, an appropriate key set can be selected based on the key set number included in the data 312. Data 316 converted through the process 314 is converted by the MDU conversion module 162 to SELECT_SERVICE CMD 320 (process 318). SELECT_SERVICE CMD 320 is data including the logical channel number and the key set number, and it is inputted to the card 240 and then processed (process 322). The process 322 corresponds to a process of switching a memory space in the card 240 based on the logical channel or an operation of selecting a key set based on the designation of the key set and reading the key set onto the memory if necessary.

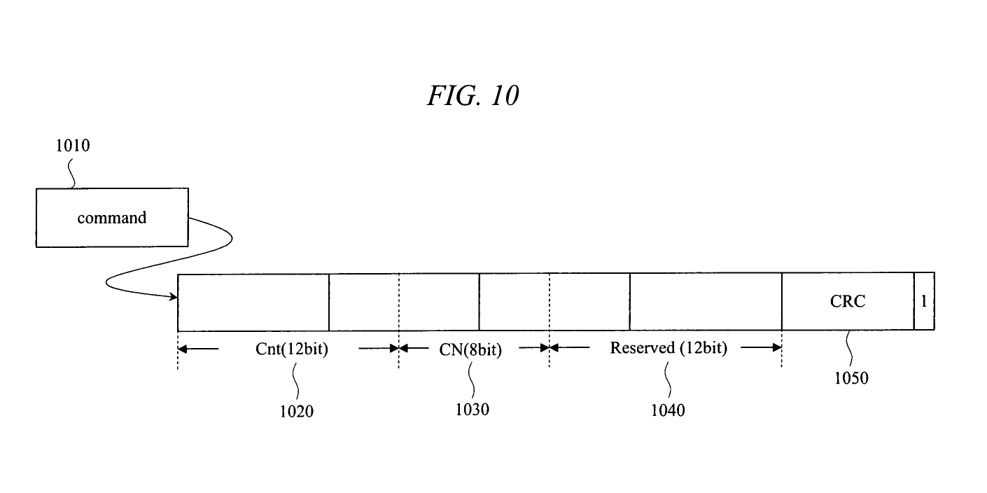

FIG. 10 depicts a format of instruction parts of data inputted to the card 240. In FIG. 10, command 1010 represents a type of data process to be executed, and CN 1030 (8 bit) represents a type of security process. CRC 1050 is the data for error check of instruction parts. Also, Cnt 1020 (12 bit) and Reserved 1040(12 bit) may not be particularly used, and may all have a value of 0. In the present embodiment, different processes are designated in the same command 1010 depending on a difference of the value of CN 1030, which is a parameter of command 1010.

The security process used in the card 240 is taken as derivatives of a single data block input instruction and a single data block output instruction. Whether these instructions are identical to those of a normal data access process in the card depends on whether a process switching instruction has been issued before these instructions. Examples of a process switching scheme include a scheme of interpreting an instruction subsequent to these instructions as a security process instruction, and a process of replacing the instructions with security process instructions until a process switching instruction is issued once again. Also, an instruction for the security process may be provided as an instruction separate from other instructions, or the function may be switched through physical or electrical switching. The electrical switching mentioned here corresponds to, for example, a process of switching the process depending on whether a signal line provided for determining the type of process is at a High or Low level. When the security process is selected with CN 1030, for example, first two bits represent a target logical channel number, and the subsequent six bits represent the type of security process. FIG. 9 depicts a security function of the card 240 of the card 240 designated based on the above rule.

In an instruction set shown in FIG. 9, Command Name (901) represents a name of a command which can be interpreted by the card 240, and Command & Argument (902) represents a type of Command 1010 as a base and a value to be set in CN 1030. Here, an instruction described as “ACMD17” corresponds to a security process instruction derived from a single data output instruction, and an instruction described as “ACMD24” corresponds to a security process instruction derived from a single data input instruction. Also, a hexadecimal number specified by “Arg” represents a value to be set in lower six bits of CN 1030. This instruction set can have a different name, a different data size, and a different way of specifying each function depending on the type of the TRM module 164.

As a result of the process 322 shown in FIG. 3 described above, the MDU conversion module 162 performs a process 324 of checking the output error state, and it notifies the DRM agent module 140 of the check result. Here, in the case of occurrence of an error, if no DRM entity is present, the selected logical channel is not available, or the selected key set is not present, the DRM agent 140 can perform a process of reporting the end of the process or a process of re-issuing an instruction with a different combination. In the case where no error is present, the DRM agent module 140 reads a certificate included in the selected key set (process 326). An instruction for this process is converted by the MDU conversion module 162 to SEND_CERT CMD 330 (process 328). The SEND_CERT CMD 330 is processed by the card 240 (process 332). The process 332 corresponds to, for example, a process of reading and outputting a certificate included in the key information set in the process 322. However, if no certificate is included in the key set, an error may be returned. The outputted certificate 334 is converted through a conversion process 336 by the MDU conversion module 162 to DESTINATION_CERT MDU 338. DESTINATION_CERT MDU 338 is converted by the DRM agent 140 to OPEN PDU 342 and then outputted (process 340). OPEN PDU 342 includes information such as a protocol version, message ID, content ID, and certificate. After transmission of OPEN PDU 342, the DRM agent 140 makes a transition to a state of waiting for ESTABLISH PDU 350. If this state continues longer than a predetermined period of time, the DRM agent module 140 transmits OPEN PDU 342 once again. The timing of re-issuing OPEN PDU 342 can be varied for each interface for use in communication.

When the DRM agent module 140 receives ESTABLISH PDU 350, the DRM agent module 140 generates SOURCE_KEY MDU 354 from ESTABLISH PDU 350 and transmits it to the DRM entity module 160 (process 352). SOURCE_KEY MDU 354 can include data obtained by encrypting a first session key generated by the communication counterpart terminal (110) with a public key included in the public key certificate (encrypted first session key), a transaction ID, and others. The MDU conversion module 162 extracts the encrypted first session key from SOURCE_KEY MDU 354, converts the extracted key to SET_SESSION_KEY CMD 358 (process 356), and then transmits the conversion result to the card 240 to be processed (process 360). The process 360 correspond to, for example, a process of decrypting the first session key encrypted with the public key by using a relevant secret key to extract the first session key and setting it to the memory. When the process 360 ends, the MDU conversion module 162 processes a response (process 362). The process 362 corresponds to, for example, a process of determining whether the process 360 of the card 240 has normally ended. In response, the DRM agent module 140 converts the transaction ID included in ESTABLISH PDU 350 to TRANSACTION_ID MDU 366 (process 364). TRANSACTION_ID MDU 366 is converted by the MDU conversion module 162 to START_TRANSACTION CMD 370 (process 368), and it is then processed by the card 240 (process 372). The process 372 corresponds to, for example, an operation of storing the inputted transaction ID in the memory. When this process ends, the MDU conversion module 162 processes a response (process 374). The process 374 corresponds to, for example, a process of determining whether the process 372 has normally ended. In response, the MDU conversion module 162 generates ESTABLISH_WRITE_SESSION CMD 378 (process 376), and sends it to the card 240 to be processed (process 380). The process 380 corresponds to, for example, a process of generating a second session key by using a random number generator in the card 240 and encrypting the second session key with the first session key for transmission. Also, data to be encrypted with the first session key and then sent may include an issue date/time of a certificate revocation list in the card 240 and a public key unique to the card 240. At the same time, an operation of storing the second session key and the transaction ID as log information and a process of changing the state of transferring the license information during execution can be performed. An encrypted second session key 382, which is the data obtained by encrypting the outputted second session key with the first session key, is converted by the MDU conversion module 162 to DESTINATION_KEY MDU 386 (process 384). DESTINATION_KEY MDU 386 is passed to the DRM agent module 140, and the DRM agent module 140 generates GET_LICENSE PDU 390 from DESTINATION_KEY MDU 386 and transmits it to the communication counterpart terminal 110 (process 388). In the process 388, information regarding license information which can be accepted and is desired to be acquired (list of requested license information) can be taken as a part of GET_LICENSE PDU 390. For example, when license information is acquired from the counterpart terminal 110, there may be a case in which the license information is desired to be temporarily read for replay and a case in which the license information included in the counterpart terminal 110 is desired to be moved or copied to the terminal 100. Here, if information regarding the type of access is included in the license information list, the counterpart device 110 can confirm the request from the terminal 100. For example, in the case of temporary reading for replay, no parameter to be processed in the TRM module 164 is required. Therefore, a parameter to be processed in the TRM module 164 is not included therein, which makes it possible to interpret that this is the temporary reading for replay. As means for determining a move process or a copy process, a license information list at the time of moving and a license information list at the time of copying are notified in advance to the terminal 100, and either one of the lists is selected to switch between the moving process and the copying process. However, it is the user of the counterpart terminal 110, the application (130), or the DRM agent module (140) that determines whether each of move, copy, and replay is available under the conditions. If the specified conditions cannot be accepted, transfer of the license information can be rejected. GET_LICENSE PDU 390 includes information such as a message ID, transaction ID, encrypted second session key, and license information list.

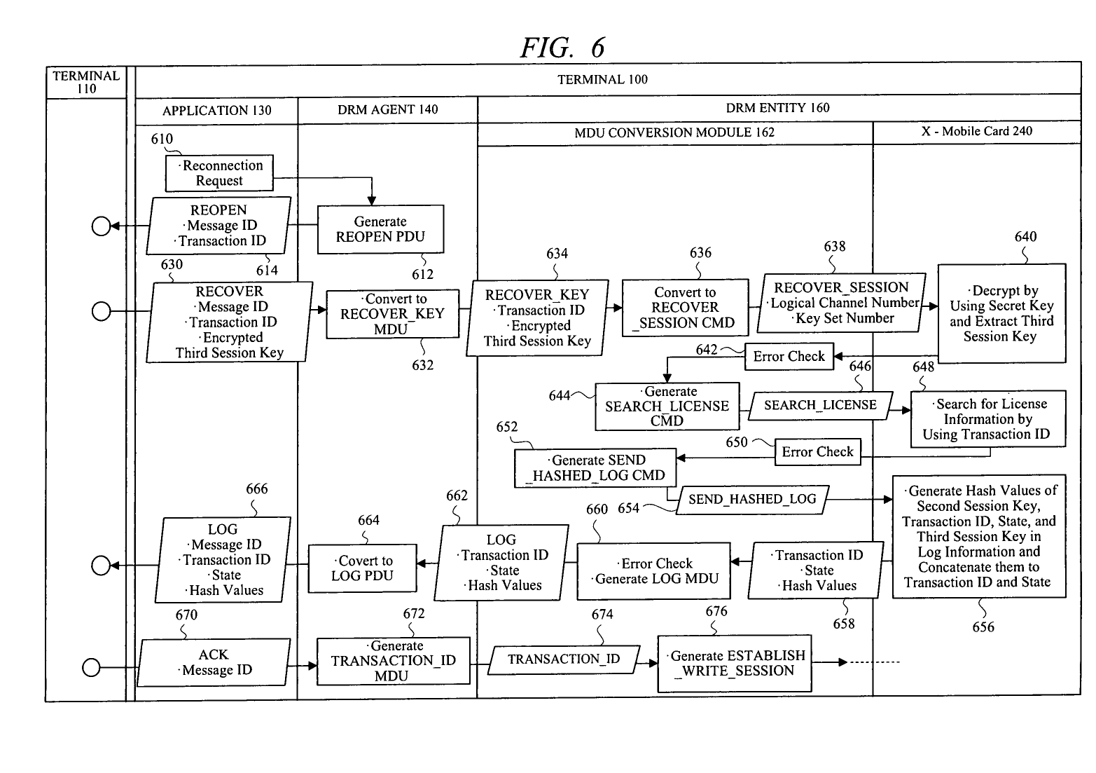

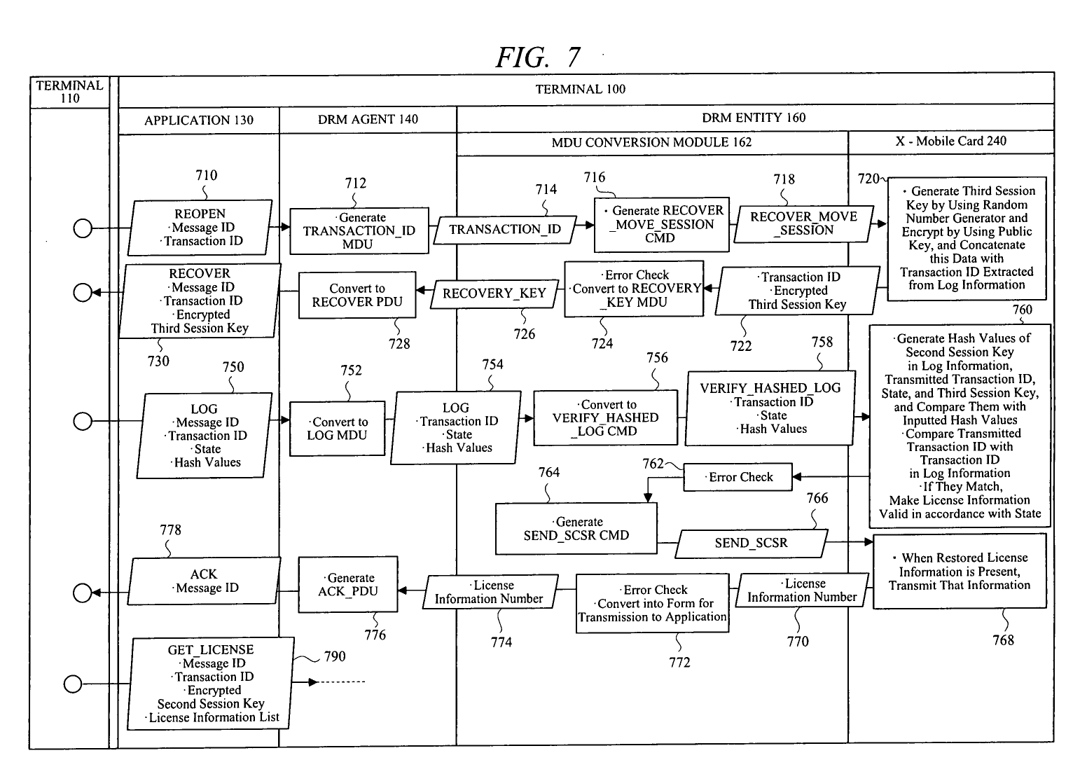

After the transmission of GET_LICENSE PDU 390, the DRM agent module 140 can make a transition to a state of waiting for RES_GET_LICENSE PDU 410 shown in FIG. 4. If this state continues longer than a predetermined period of time, the DRM agent 140 transmits REOPEN PDU 610 as shown in FIG. 6 and FIG. 7. The timing of issuing REOPEN PDU 610 can be varied for each interface used in the communication. The operation regarding issuance of REOPEN PDU is shown in FIG. 6 and FIG. 7.

In FIG. 4, when the DRM agent 140 receives RES_GET_LICENSE PDU 410, the DRM agent 140 converts it to LICENSE MDU 414 (process 412). When the MDU conversion module 162 receives LICENSE MDU 414, the MDU conversion module 162 converts it to SET_LICENSE CMD 418 (process 416). RES_GET_LICENSE PDU 410 includes a message ID and encrypted license information. LICENSE MDU 414 includes the encrypted license information. SET_LICENSE CMD 418 includes the encrypted license information.

Here, the storage device 200 which it detachable connected to the terminal such as the card 240 supports a single transfer scheme for transferring one block of data to an address specified by the terminal and a multi-transfer scheme for sequentially writing a plurality of blocks to the specified address. The block mentioned here is a unit of data per communication. The card 240 includes a data processing unit which can be used as a normal storage and a security processing unit for performing a security process. When the terminal causes these two processes to be separately operated, several problems may arise. A first problem relates to timing of issuance of an instruction. In the case where an interrupt of data transfer occurs during data transfer for the security process and the interrupt of data transfer is given a higher priority than the security process, it is desired that a multi-data transfer process for the security process is temporarily suspended, and after the end of data transfer, the multi-data transfer for the security process is resumed. In this case, if the mechanism is such that a security process for the received data is started with using a data transfer stop instruction as a trigger, the data for the security process cannot be divided. Moreover, even in the case where the continued data transfer for the security process is resumed, if the data transfer is resumed with the same instruction set, it cannot be determined whether such resuming is an invalid process or a continued process. For its solution, when the data size of the LICENSE MDU 414 cannot be processed through a single transfer process, the MDU conversion module 162 can transfer that data to the card 240 by using two types of instructions, that is, SET_LICENSE CMD 418 and EXT_SET_LICENSE CMD 426. SET_LICENSE CMD 418 is a data transfer instruction for a process corresponding to LICENSE MDU 414, and EXT_SET_LICENSE CMD 426 is a data transfer instruction in the case where the remaining data is still present. Either instruction has a function to start a security process when data transfer ends. When data transfer for the security process is suspended, EXT_SET_LICENSE CMD 426 is issued. By doing so, the card 240 can determine that it represents continued data. These instructions may be single data transfer instruction or multi-data transfer instruction. In the following description, these instructions are assumed to be single data transfer instruction.

SET_LICENSE CMD 418 is transmitted to the card 240 and processed therein (process from the process 420). When the card 240 receives SET_LICENSE CMD 418, the card 240 determines a data length contained in SET_LICENSE CMD 418 to acquire information allowing recognition of how much data will come later. The received data may be stored in a cache in the module or may be saved in a part of the storage device if the cache is not sufficiently large. If a block not transferred yet is present (Yes in process 420), a response is returned to the MDU conversion module 162. The MDU conversion module 162 checks the error state (process 422), and if there is a block not transferred yet, a continued block is issued as EXT_SET_LICENSE CMD 426 (process 424). When EXT_SET_LICENSE CMD 426 is inputted to the card 240, it is again checked whether there is a block not transferred yet, and if there is a block not transferred yet, the processes are repeated from the process 424. At this time, if waiting for the next data, the received data is saved in the cache if the cache is sufficient or the received data is saved in a part of the storage device if the cache is not sufficient. If all blocks have been already transferred (No in process 420), the card 240 decrypts the encrypted license information, extracts the license information and the certificate revocation list, and then stores them. However, if the license information is encrypted with a public key, the license information is decrypted with an individual secret key of the card 240 and then stored, or it is decrypted at the time of output (process 428).

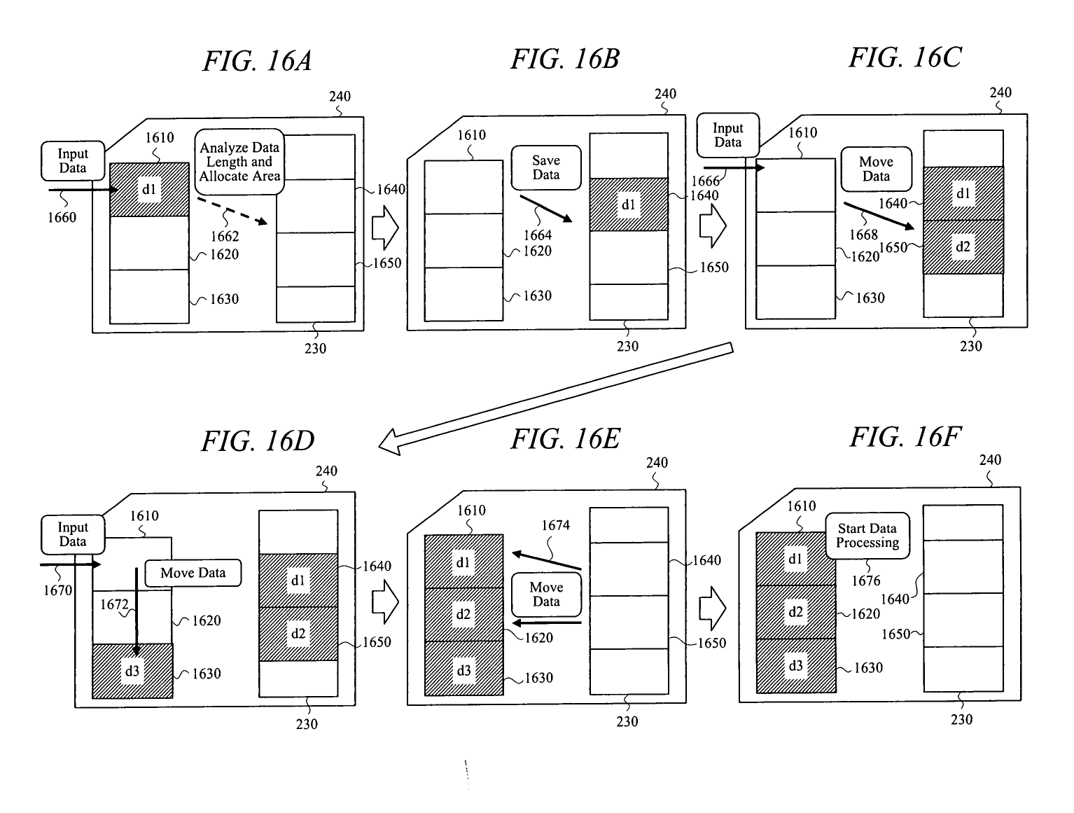

FIG. 16A to FIG. 16F depict the operation in the card 240 at this time in detail. Storage areas 1610, 1620, and 1630 represent buffers on the card 240. The controller chip 220 has such buffers. The buffers 1610, 1620, and 1630 have the same size corresponding to the data size which can be transferred at one time with a single transfer process.

In FIG. 16A, when the card 240 receives a data inputted with SET_LICENSE CMD 418, the card 240 stores the data (for example, d1) in the buffer 1610 which is a buffer for input/output (process 1660). The card 240 calculates an entire data size from tag information (information at the head) of the received data (d1), and then allocates a save area on an area (security processing unit), which is managed by the card 240 and cannot be operated by the user, on the flash memory of the flash memory chip 230 (process 1662). If the input data size is larger than the size of the flash memory which can be used for this saving, an error may be returned. In this case, the case where data having an entire data size larger than a size of two buffers and equal to or smaller than a size of three buffers (the data is assumed to be composed of d1, d2, and d3) is to be sent will be described.

In FIG. 16B, when save data (d1) can be stored, the card 240 saves the data (d1) on the buffer 1610 in an area 1640 on the flash memory (process 1664). In FIG. 16C, when a data input is next provided with EXT_SET_LICENSE CMD 426, the card 240 temporarily stores this data (d2) in the buffer 1610 (process 1666), and then saves the data (d2) on the buffer 1610 in an area 1650 on the flash memory since transfer of entire data has not been yet completed (process 1668). In FIG. 16D, when a data input is further provided with EXT_SET_LICENSE CMD 426, the card 240 temporarily stores this data (d3) in the buffer 1610 (process 1670), and then, since transfer of the entire target data (d1 to d3) has been completed, the data (d3) on the buffer 1610 is copied (moved) to the buffer 1630 based on the entire data size and the order (process 1672). In FIG. 16E, the data (d1, d2) stored in the areas 1640 and 1650 on the flash memory are copied (moved) to the buffers 1610 and 1620, respectively, based on the entire data size and the order (process 1674).

In FIG. 16F, the data (d1 to d3) are stored in the buffers 1610, 1620, and 1630, respectively in the order of the transmission from the terminal (110). The card 240 can start a process by using these data (d1 to d3) (process 1676). Since data transmitted with SET_LICENSE CMD and EXT_SET_LICENSE CMD have been encrypted in a format correlative with the order of data, such an effect that the number of times of sorting the data can be reduced when data are successively disposed and process efficiency can be improved can be achieved. In particular, when the transmitted data is encrypted so as to have a correlation with other parts in that data and the storage device 200 (card 240) decrypts the received data, it is possible to achieve an effect of increasing process efficiency by disposing the data in successive addresses as shown in FIG. 16F. Also, with the use of this scheme, even if another instruction comes between SET_LICENSE CMD and EXT_SET_LICENSE CMD or between EXT_SET_LICENSE CMD and EXT_SET_LICENSE CMD, the process can advantageously continue without destruction of the data. Also, in this scheme, unlike the case of newly adding a buffer for saving data to the internal RAM or the like, the flash memory 230 and a part of the HDD can be allocated for use. Therefore, it is possible to reduce the manufacturing cost of a semiconductor device. Furthermore, since a storage device such as a flash memory or HDD has a feature that data is written in a unit of a predetermined size at one time, higher-speed processing can be achieved by collectively writing a certain amount of data than by sequentially writing the transmitted data. Therefore, if the internal RAM has a sufficient space, the data transfer speed can be increased more when the space is allocated to the buffers for data transfer as many as possible than when buffers for an encryption process occupy the RAM. Therefore, by using the process in the above scheme according to the present embodiment, implementation efficiency can be advantageously increased.

This mechanism can be applied not only to the case of SET_LICENSE CMD but also to other processes. As for a management scheme at the time of data input, the scheme of SET_LICENSE CMD is used. As for a management scheme at the time of data output, a scheme of SEND_MOVE_LICENSE CMD is used, which will be described further below.

Also, the card 240 can read a part of data to the memory when the memory provided as a buffer is smaller than the saved data at the time of the process 1674 (data move from the save area to the buffer). Furthermore, in this case, it is also possible to perform the process while considering the area provided on the buffer as data on the memory without performing the process 1674. In this case, when a memory access occurs in the process 1676, a block including the specified address is read onto the memory of the buffer, and when an access request for another address of data in a different block occurs, the memory contents are written back to a corresponding buffer, and then the block to be accessed is read.

In FIG. 4, the certificate revocation list may be stored or updated after checking a signature, an issue date/time, and an issuer (process 428). When the process 428 ends, the MDU conversion module 162 checks an output from the card 240 (process 432), and then reports the check result to the DRM agent module 140. When the DRM agent module 140 receives the result of the process 432, the DRM agent module 140 searches the content table for a storage number of target license information based on the transaction ID (process 434). At this time, the application 130 can set a permission or prohibition of overwriting of the license information (process 436). Normally, the license information does not have to be erased once it is written. However, if the area for storing the license information becomes short or if the license information expires to become invalid, it is possible to overwrite by specifying the overwriting even if the license information is already present at the spot. However, if a determination about a storage position is made at the DRM entity 160 side such that data is stored in an area with the smallest empty number, specifying a storage position is not necessary. In this case, information about where the license information is stored can be acquired through the process of reading the status information 1180.

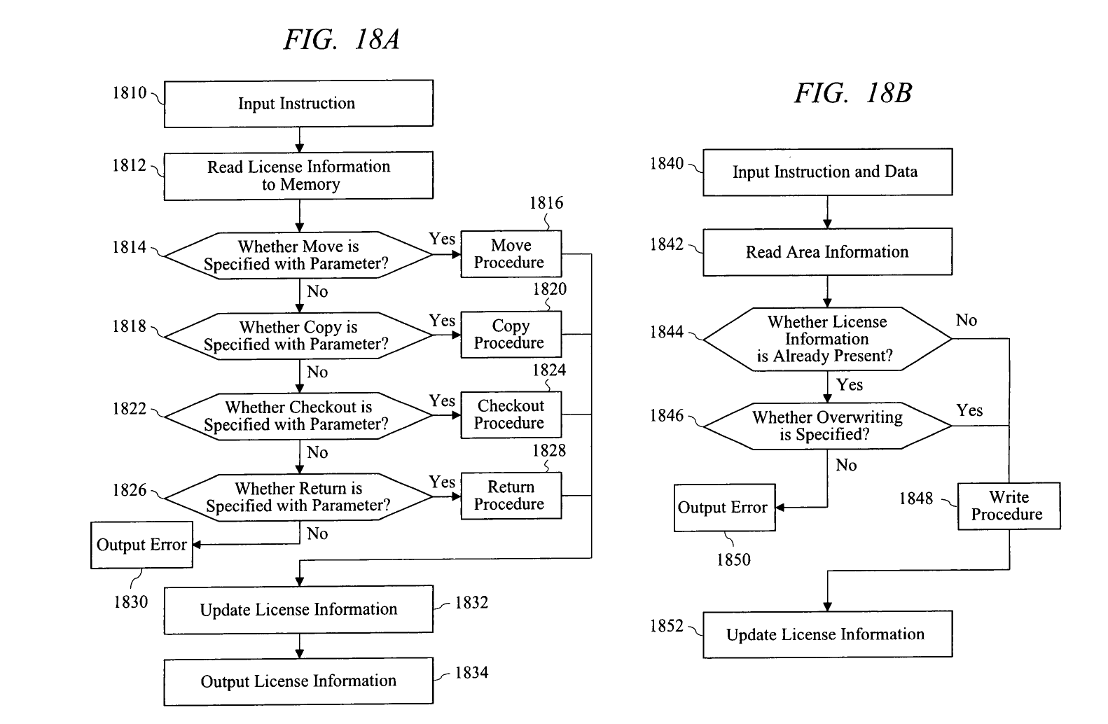

FIG. 18A and FIG. 18B depict a procedure at the time of writing the license information. In FIG. 18B, when an instruction WRITE_LICENSE CMD is inputted (process 1840), the card 240 reads area information (license information) of the specified storage area (process 1842). In the area information, information about whether the license information has already been written is written. Based on this information, the card 240 checks whether the license information has already been written in the target area (process 1844). In the state where the information has not been written (No in process 1844), a write procedure 1848 can be performed. The write procedure 1848 mentioned here corresponds to, for example, a process of erasing the area for writing or a process of preparing for update of the table. Even when the information has been already written (Yes in process 1844), if the overwriting has been specified in WRITE_LICENSE CMD 442 (Yes in process 1846), the write procedure 1848 can be performed. Otherwise (No in process 1846), the card 240 can return an error (process 1850). If the write procedure 1848 succeeds, the license information can be written and updated (process 1852). As described above, by specifying the overwriting together with WRITE_LICENSE CMD 442, it becomes unnecessary to provide a dedicated instruction. For example, in the case where a dedicated instruction has to be provided and overwriting on a certain area has already been prohibited, if the area becomes short in the course of a license information transfer process, an instruction for canceling the prohibition of overwriting has to be interrupted and executed in a series of process for license information transfer. A process for this purpose will cause an increase in implementation cost and a decrease in process speed, compared with the case where overwrite prohibition and its cancellation can be performed with only WRITE_LICENSE CMD.

In FIG. 4 described above, the storage position and the parameter (data 438 including a storage number and specification of overwriting) is converted by the MDU conversion module 162 to WRITE_LICENSE CMD 442 (process 440). WRITE_LICENSE CMD 442 is sent to the card 240 and then processed therein (process 444). The process 444 corresponds to, for example, a process of checking the area specified as the storage position in accordance with the specification of the parameter and determining whether to write the license information. At the same time, as log information, a process of updating a transaction ID in the log information with the transaction ID included in the license information and a process of setting the license information transfer into an end state (transfer end state writing) can be performed. The MDU conversion module 162 checks an error in the process 444 (process 446), and reports the check result to the DRM agent module 140 or the application 130. The DRM agent module 140 or the application 130 determines whether to continuously perform the process (license information transfer process) (process 448). If the process is not performed continuously, the DRM agent module 140 generates CLOSE PDU 452 and transmits it to the counterpart terminal 110 (process 450). CLOSE PDU 452 includes information about the message ID and the transaction ID.

After the transmission of CLOSE PDU 452, the DRM agent module 140 can make a transition to a state of waiting for CONFIRM PDU 460. If no response comes for a predetermined time period, the DRM agent module 140 can transmit CLOSE PDU 452 again. When the DRM agent module 140 receives CONFIRM PDU 460, the DRM agent module 140 releases the DRM entity module 160 to end the process (process 462).

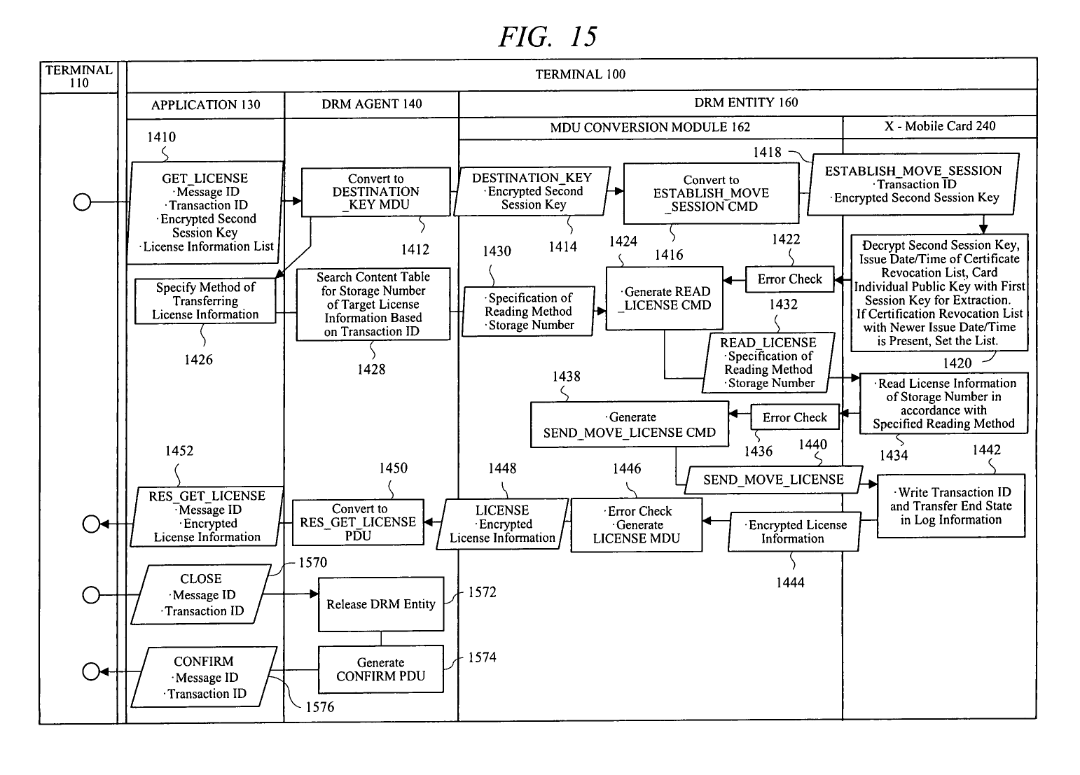

Similar to the above, a process of acquiring the license information performed at the terminal 110 side cab be performed at the terminal 100 side. FIG. 5 and FIG. 15 depict a procedure at this time.

In FIG. 5, the DRM agent module 140 receives OPEN PDU 510, the DRM agent module 140 can select a key set for use and a DRM entity (process 512). However, if any one of DRM entity modules 160 has been already selected or it is known that only one DRM entity module is present, this selection of the DRM entity module 160 can be omitted. Also, if the card 240 has logical channels and can simultaneously perform a plurality of processes, a logical channel to be used is selected. Furthermore, if there are a plurality of key sets available, a key set can be selected by specifying a key set number for use. The key set and logical channel number for use (data 514) are converted by the MDU conversion module 162 to SELECT_SERVICE CMD 518 (process 516), and it is sent to the card 240 and processed therein (process 520). The process 520 corresponds to, for example, a process of reading the key set onto the memory if necessary based on the specified key set number, and a process of setting a memory area for the specified logical channel.

When the process 520 ends, the MDU conversion module 162 checks whether an error is present (process 522), and then reports the check result to the DRM agent module 140. The DRM agent module 140 extracts a certificate included in OPEN PDU 510 sent from the communication destination terminal 110 to generate DESTINATION_CERT MDU 526 (process 524). DESTINATION_CERT MDU 526 is converted by the MDU conversion module 162 to VERIFY_CERT CMD 530 (process 528), and is then sent to the card 240 and processed therein (process 532). The process 532 corresponds to, for example, a process of verifying the certificate by using a public key of a certificate issuer contained in the specified key set and extracting the public key when verification is successful.

When the process 532 ends, the MDU conversion module 162 checks the presence of an error (process 534), and if no error is present, it generates SEND_SESSION_KEY CMD 538 (process 536) and transmits it to the card 240 for process (process 540). The process 540 corresponds to, for example, a process of generating a first session key by using a random number generator in the card 240 and encrypting the first session key by using the verified public key to transmit it. When the MDU conversion module 162 receives the encrypted first session key 542 outputted from the card 240, the MDU conversion module 162 immediately checks an error. If no error is present, it converts the encrypted first session key 542 to SOURCE_KEY MDU 546 (process 544) and sends it to the DRM agent module 140. When the DRM agent module 140 receives SOURCE_KEY MDU 546, the DRM agent 140 generates a transaction ID corresponding to the content ID specified in OPEN PDU 510, and also generates ESTABLISH PDU 550 from the generated transaction ID and SOURCE_KEY MDU 546 and then transmits it to the communication counterpart (process 548).

In FIG. 15, after the transmission of ESTABLISH PDU 550, the DRM agent module 140 makes a transition to a state of waiting for GET_LICENSE PDU 1410. If this state continues for a predetermined period of time or longer, the DRM agent module 140 can suspend the process while keeping the state at that time. GET_LICENSE PDU 1410 includes information such as the message ID, transaction ID, encrypted second session key, and license information list.

When the DRM agent 140 receives GET_LICENSE PDU 1410, the DRM agent 140 generates DESTINATION_KEY MDU 1414 by using a second session key encrypted with the first session key, an update date/time of the certificate revocation list, and an individual public key of the communication-destination DRM entity in GET_LICENSE PDU 1410, and the license information list (process 1412). When the MDU conversion module 162 receives DESTINATION_KEY MDU 1414, the MDU conversion module 162 generates ESTABLISH_MOVE_SESSION CMD 1418 by using the second session key encrypted with the first session key, the update date/time of the certificate revocation list, and the individual public key of the communication-destination DRM entity in DESTINATION_KEY MDU 1414 (process 1416), and transmits the generated ESTABLISH_MOVE_SESSION CMD 1418 to the card 240 for process (process 1420). The process 1420 corresponds to, for example, an operation of decrypting the data encrypted with the first session key and extracting the second session key, the update date/time of the certificate revocation list, and the individual public key of the communication-destination DRM entity. If the update date/time of the certificate revocation list is present, the relevant certificate revocation list is searched to compare it with the update date/time. If the date/time in the list is newer than the searched update date/time, a transfer of the certificate revocation list is prepared so as to transmit the newer date/time by using SEND_MOVE_LICENSE CMD 1440. If the individual public key of the communication-destination DRM entity is included, the individual public key is set on the memory. When the process 1420 ends, the MDU conversion module 162 checks the presence of an error (process 1422), and if no error is present, it generates READ_LICENSE CMD 1432. At this time, the application 130 specifies a method of transferring the license information based on the license information list included in GET_LICENSE PDU 1410 (process 1426). The DRM agent module 140 searches the content table for a storage number of target license information based on the transaction ID (process 1428), and then generates data (specification of a reading method and the storage number) 1430 by combining the storage number and the specification of the license information. READ_LICENSE CMD 1432 is generated based on this data 1430 (process 1424). As the specified reading method mentioned here, a predetermined method can be adopted without complying with the specification of the license information list included in GET_LICENSE PDU 1410. If a transfer method is defined in advance, the license information list may not be included in GET_LICENSE PDU 1410. Conversely, if an unsupported license information list comes, the DRM agent module 140 or the application 130 does no allow a process of transferring the license information and can end the process. Alternatively, it returns an error until a correct access condition is sent.

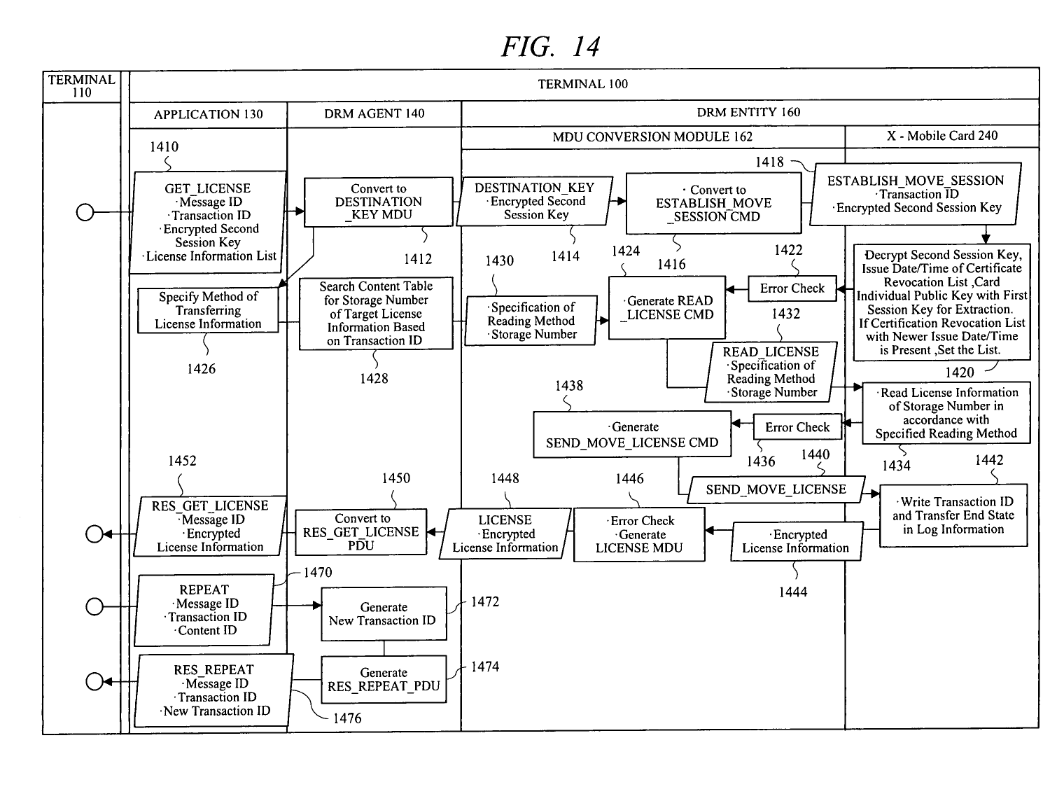

In the process of transferring the license information in FIG. 5 and FIG. 15, the transfer method is divided into a move process, a copy (duplication) process, a checkout process, and a return process. The move process is an operation of passing the license information as it is to the counterpart, in which the license (right) is decreased by the amount equivalent to that move at the move source and the license information is increased at the move destination by that decreased amount. In the move process, a limit of the number of times of the move can be defined. The copy process is an operation of transferring information obtained by copying all or a part of the license (right) of the copy source, while keeping the license (right) of the copy source. In the copy process, a limit of the number of times of the copying can be defined. The checkout process is one type of the copy process, in which information obtained by copying all or a part of the license (right) of the checkout source is transferred to the checkout destination, while keeping the license (right) of the checkout source. However, the checkout source retains checkout information, and during checkout, a restriction occurs in checkout of the same license information to other destinations. For example, the license information with the upper limit of the number of checkouts set as three can be checked out three times to other DRM entities. However, after checking out the information three times, next checkout cannot be performed. Furthermore, when the license information is returned from the DRM entity to which the information is checked out, the checkout of the license information can be allowed again by that return. At the time of checkout, original license information cannot be used during checkout, or the license information can be used only at the destination of the checkout. However, when returning the checked-out license information, a return process is used. A transfer method to be used can be selected by the transfer source irrespective of the license information list. That is, the transfer-destination DRM agent may not be able to explicitly select the type of transfer process. Also, the DRM agent can impose a restriction on an available transfer method by identifying the communication counterpart. This restriction corresponds to, for example, an operation of permitting a network transfer with a local IP address but prohibiting copy and move processes for a global IP address, an operation of permitting a transfer only to a MAC address registered in advance, or an operation of prohibiting a transfer to a specified MAC address, based on communication means and a IP address and a MAC address of the communication-destination. In the card 240, an identification number is assigned to each of the move process, the copy process, the checkout process, and the return process. When the card 240 receives READ_LICENSE 1432 of FIG. 14, the card 240 performs a process in accordance with the specified identification number.

FIG. 18A depicts a procedure at this time. When READ_LICENSE CMD 1432 is inputted (process 1810), the card 240 reads the license information onto the memory (process 1812). Next, processes are performed in accordance with the processes specified by instruction parameters. Note that process 1814, process 1818, process 1822, and process 1826 may be performed in a different order. If a move process is specified by parameters (process 1814), it is checked whether a move process is permitted by the license information, and if permitted, a process for a move procedure is performed so as to satisfy restrictions (process 1816). The restrictions to be satisfied mentioned here correspond to, for example, a restriction on the number of times of move and a restriction regarding the contents of the license information to be moved. If there is a restriction on the number of times of move, the number of times of move of the license information to be moved is decreased by one, and then the license information is stored in a data storage area for transfer. If there is a restriction regarding the contents such as restricting the transmission of a specific parameter, the license information to be transmitted is set in accordance with this restriction.

Also, if a copy process is specified (process 1818), it is checked from the license information whether a copy process is permitted, and if permitted, a process for a duplication procedure is performed so as to satisfy restrictions (process 1820). The restrictions to be satisfied mentioned here correspond to, for example, restriction on the number of times of copy and a restriction regarding the contents of the license information to be copied. If there is a restriction on the number of times of copy, the number of times of copy of the license information to be copied is decreased by one, and then the license information is duplicated in a data storage area for transfer. If there is a restriction regarding the contents such as restricting the transmission of a specific parameter, the license information to be transmitted is set in accordance with this restriction. This process corresponds to, for example, a process of setting the number of times of copy to 0 irrespective of the number of times of copy set in the original license information, or a process of prohibiting the copy as being permission information, for the purpose of prohibiting a second-generation duplication.

Also, when a checkout process is specified (process 1822), it is checked from the license information whether a checkout process is permitted, and if permitted, a process of a checkout procedure is performed so as to satisfy restrictions (process 1824). The restrictions to be satisfied mentioned here correspond to, for example, a restriction on the number of times of checkout and a restriction regarding the contents of the license information to be checked out. If there is a restriction on the number of times of checkout, the number of times of checkout of the license information to be checked out is decreased by one, and then the license information is duplicated in a data storage area for transfer. If there is a restriction regarding the contents such as restricting the transmission of a specific parameter, the license information to be transmitted is set in accordance with this restriction. This process corresponds to, for example, a process of adding information indicative of checkout and recording information indicative of a terminal where a checkout process has occurred at the checkout source and the checkout destination so as to distinguish second-generation checked-out license information from the original license information, and a process of setting the number of times of checkout to 0 irrespective of the restriction on the number of times of checkout in the original license information or prohibiting copy as being permission information, for the purpose of prohibiting a move or copy of the license information after checkout.

Furthermore, when a return process is specified (process 1826), it is checked whether the license information has been checked out, and if so, a process of a return procedure is performed so as to satisfy restrictions (process 1828). The restrictions to be satisfied mentioned here correspond to, for example, a restriction regarding the return-destination terminal and the license information. Since the return process is an operation performed to the specific terminal or the terminal having specific license information, it is preferable to determine in advance whether the communication counterpart terminal is appropriate as a return destination at the time of returning. Also, it is preferable to include the information capable of recognizing the checked-out license information in the license information moved in the return process so that the return destination can recognize the checked-out license information. The information for recognizing the checked-out license information corresponds to, for example, an identification number of the check-out source or an identification number of the license information of the check-out source. Since the information is not transferred to the check-out destination unless the checkout process is correctly performed, the fact that this information is included in the license information allows the license information transfer source to recognize that the information is the checked-out license information. Unless any of the above conditions is met, an error may be returned (process 1830). When the processes 1816, 1820, 1824, and 1828 are performed, the card 240 updates the license information based on the process results (process 1832), and then outputs and transmits the license information (process 1834). Since the above four processes are different from one another only in a course from reading the license information from the storage device 200 to storing the read information in a memory area for transfer, these processes other than the difference can be performed in common. Thus, these processes can be performed with one instruction instead of a plurality of instructions, thereby achieving commonality of the process contents.

In FIG. 14, the card 240 receives and processes READ_LICENSE 1432 (process 1434). The process 1434 corresponds to, for example, an operation of reading the specified license information to the memory and determining whether a process using the specified transfer method can be performed within the range of the license information. When the process 1434 ends, the MDU conversion module 162 receives the process results to determine whether a next instruction can be issued (process 1436). If an instruction can be issued, SEND_MOVE_LICENSE CMD 1440 can be issued (process 1438). When the card 240 receives SEND_MOVE_LICENSE CMD 1440, the card 240 performs a data process (process 1442). The process 1442 corresponds to, for example, a process of extracting all or a part of the license information in accordance with the specified transfer scheme; encrypting the extracted information with the individual public key of the communication-destination DRM entity received in ESTABLISH_MOVE_SESSION CMD 1418 if necessary; if a certificate revocation list to be sent as a result of the process 1420 is present in that information, concatenating the list with the encrypted license information; encrypting data after concatenation with the second session key extracted in the process 1420; and sending the encrypted data. Also at the same time, the transaction ID of the sent license information is stored in the log information to make the state of sending the license information to a completed state. When the MDU conversion module 162 receives encrypted license information 1444 outputted from the card 240, the MDU conversion module 162 checks an error, and if no error is present, the encrypted license information 1444 can be converted to LICENSE MDU 1448 (process 1446) Furthermore, at this time, the length of the sent encrypted license information is checked, and if the sent data does not satisfy this length, EXT_SEND_MOVE_LICENSE CMD is issued to read continued data. In this case, a process of reflecting the result onto the log information in the process 1442 is performed after the entire data is outputted with EXT_SEND_MOVE_LICENSE. Still further, when it is found that the data sent in the process 1442 is larger than the transfer block size, the remaining data is stored in the buffer for the security process or is temporarily stored on the storage device. This information can be erased after sending the data. When EXT_SEND_MOVE_LICENSE CMD is issued in a state where the entire data has been sent, the card 240 may return an error.

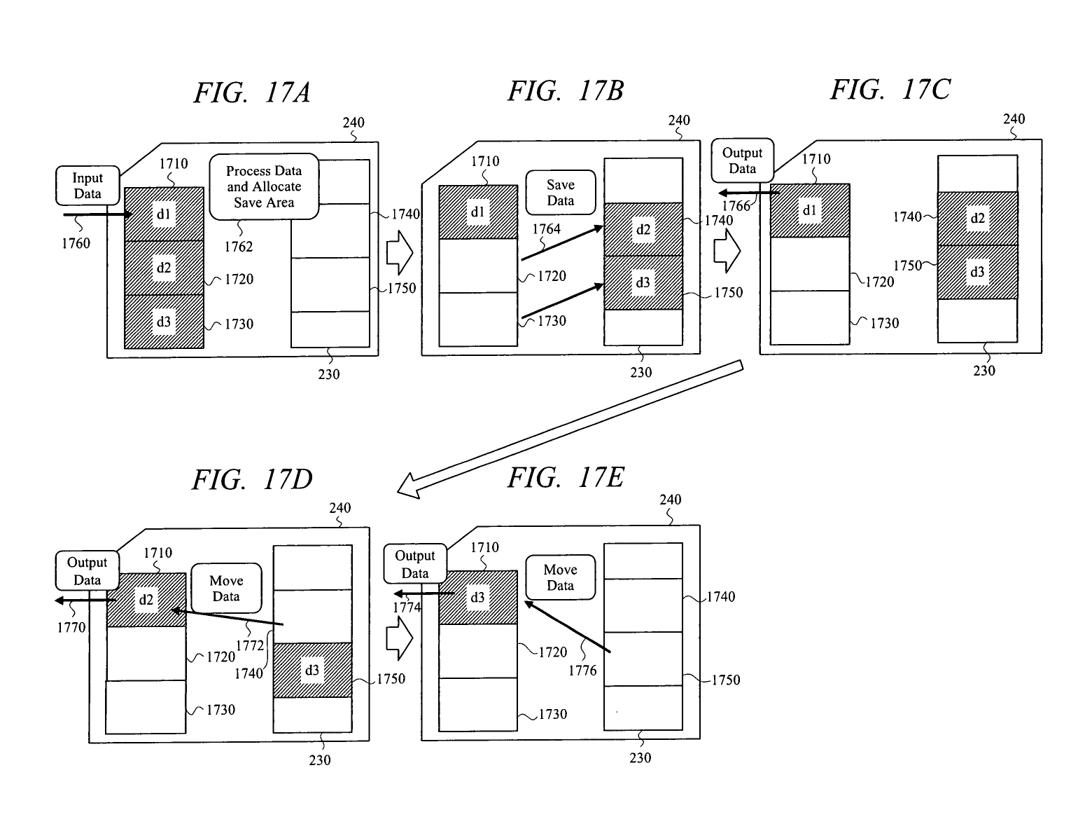

FIG. 17A to FIG. 17E describe details of the operation in the card 240 at this time. Similar to FIG. 16A to FIG. 16F, storage areas 1710, 1720, and 1730 represent buffers on the card 240, and these buffers have the same size corresponding to a data size which can be transferred at one time through a single transfer process. In FIG. 17A, when a process of an input of SEND_MOVE_LICENSE CMD 1440 ends (process 1660), the card 240 checks the entire size of the inputted data, and then allocates a save area on an area, which is managed by the card 240 and cannot be operated by the user, on the flash memory of the flash memory chip 230 (process 1762). If the output data size is larger than the size of the flash memory which can be used for this saving, an error may be returned. In this case, the case where data having a size larger than a size of two buffers and equal to or smaller than a size of three buffers (d1 to d3) is to be sent will be described..

In FIG. 17B, data (d2, d3) in the buffers 1720 and 1730 which cannot be sent at one time in this process are saved on save areas 1740 and 1750, respectively (process 1764). Then, in FIG. 17C, data on the buffer 1710 is outputted (process 1766). In FIG. 17D, when the card 240 receives EXT_SEND_MOVE_LICENSE CMD, the card 240 copies (moves) the data (d2) on the save area 1740 to the buffer 1710 (process 1772) and then outputs the data (d2) on the buffer 1710 (process 1770). Further, in FIG. 17E, when the card 240 receives EXT_SEND_MOVE_LICENSE CMD, the card 240 copies (moves) the data (d3) on the save area 1750 to the buffer 1710 (process 1776) and then outputs the data (d3) on the buffer 1710 (process 1774).

With the use of this scheme, even if another instruction comes between SEND_MOVE_LICENSE CMD and EXT_SEND_MOVE_LICENSE CMD or between EXT_SEND_MOVE_LICENSE CMD and EXT_SEND_MOVE_LICENSE CMD, the process can advantageously continue without destruction of the data. Also, in this scheme, unlike the case of newly adding a buffer for saving data to the internal RAM or the like, the flash memory 230 and a part of the HDD can be allocated for use. Therefore, it is possible to reduce the manufacturing cost of a semiconductor device.

Here, in the case where the card 240 does not support EXT_SEND_MOVE_LICENSE CMD, the data to be sent exceeds the block size in some cases because there are a plurality of certificate revocation lists to be added to the license information. At this time, if it is known that a data size after addition of one certificate revocation list is equal to or smaller than the block size, a certificate revocation list to be sent is selected. In this case, the certificate revocation lists to be sent among the plurality of certificate revocation lists are preferably sent by giving the priorities so that a certificate revocation list corresponding to the key set currently used comes first and a certificate revocation list corresponding to the key set stored in the card 240 for longer time comes next. In this case, by giving the priority to the certificate revocation list corresponding to the key set currently used in the transmission, the certificate revocation list required for a process of transferring the license information using the selected service can be transferred. Also, by selecting the key set stored in the card 240 for longer time, it is possible to sequentially register invalid keys from the key sets possibly more widely used. Consequently, even if a plurality of new certificate revocation lists cannot be transferred at one transfer, the certificate revocation list of the DRM entity module 160 of the transfer destination can be updated to a newer version by repeating the transfer process many times.

In FIG. 14, the DRM agent module 140 receives LICENSE MDU 1448, the DRM agent module 140 converts it to RES_GET_LICENSE PDU 1452 and then transmits it to the communication destination (process 1450). After the transmission of RES_GET_LICENSE PDU 1452, the DRM agent module 140 makes a transition to a state of waiting for CLOSE PDU 1570 of FIG. 15. If this state continues for a predetermined period of time, the DRM agent module 140 can suspend the process while keeping the state. In FIG. 15, when the DRM agent module 140 receives CLOSE PDU 1570, the DRM agent module 140 releases the DRM entity (process 1572) and generates CONFIRM PDU 1576 (process 1574) for transmission.

If the license information transfer process fails in the license information transfer process of FIG. 3 and FIG. 4, depending on the timing, the license information at the transfer destination is not increased in some cases even through the license information at the transfer source is decreased. At this time, the decreased license information cannot be recovered by simply performing the transfer process from the beginning again. In such a case, UDAC v2 defines a protocol for recovering the license information and resuming the transfer. However, UDAC v2 does not define a method of connecting the DRM agent and the DRM entity and an implementation scheme in the case where the DRM entity is detachable and is a storage device which allows the connection of a plurality of devices. In the present embodiment, it is possible to improve the compatibility and connectivity through conversion to an input/output format to the TRM module 164 by using the MDU conversion module 162. FIG. 6 depicts a procedure at this time.

In FIG. 6, when the connection is cut off, the application 130 can make a re-connection request to the DRM agent module 140 (process 610). However, it is also possible to perform the process 610 when the DRM agent module 140 detects that the connection is cut off. The DRM agent module 140 generates REOPEN PDU 614 and transmits it (process 612). REOPEN PDU 614 includes information such as the message ID and the transaction ID.

After the transmission of REOPEN PDU 614, the DRM agent module 140 makes a transition to a state of waiting for RECOVER PDU 630. If this state continues longer than a predetermined period of time, the DRM agent module 140 can transmit REOPEN PDU 614 once again. RECOVER PDU 630 includes information such as the message ID, the transaction ID, and an encrypted third session key.

When the DRM agent module 140 receives RECOVER PDU 630, the DRM agent module 140 generates RECOVER_KEY MDU 634 from the transaction ID and the encrypted third session key included in the RECOVER PDU 630 (process 632). The MDU conversion module 162 generates RECOVER_SESSION CMD 638 suitable for an input to the card 240 from the information about the transaction ID and the third session key encrypted with the public key included in RECOVER_KEY MDU 634 (process 636), and then transmits the generated RECOVER_SESSION CMD 638 to the card 240 for process (process 640). The process 640 corresponds to, for example, an operation of decrypting, with the corresponding individual secret key, the third session key encrypted with the input public key and an operation of storing the transaction ID in the memory. When the process 640 ends, the MDU conversion module 162 receives the process result to check whether an error has occurred (process 642), and if no error is present, it generates SEARCH_LICENSE CMD 646 (process 644) to input it to the card 240 for process (process 648). The process 648 corresponds to a process of using the transaction ID inputted in RECOVER_SESSION CMD 638 to search the license information having a transaction ID matched therewith. When the process 648 ends, the MDU conversion module 162 receives an end notification and checks the error state (process 650). If no error is present, the MDU conversion module 162 generates SEND_HASHED_LOG CMD 654 (process 652) and inputs it to the card 240 for process (process 656). The process 656 corresponds to, for example, a process of determining whether the transaction ID included in the log information is identical to the found transaction ID; if identical, calculating hash values of the second session key, the transaction ID, the state of license information transfer, and the third session key used in the previous session; and transmitting information obtained by concatenating the hash values with the transaction ID and the state of license information. Along with error check, the MDU conversion module 162 generates LOG MDU 662 from data 658 composed of the transaction ID, the state of license information transfer, and the hash values (process 660). When the DRM agent 140 receives LOG MDU 662, the DRM agent 140 converts it to LOG PDU 666 and transfers it to the communication counterpart (process 664). LOG PDU 666 includes information such as the message ID, the transaction ID, the state, and the hash values.

After the transmission of LOG PDU 666, the DRM agent module 140 makes a transition to a state of waiting for ACK PDU 670. If this state continues longer than a predetermined period of time, the DRM agent module 140 can transmit REOPEN PDU 614. When the DRM agent module 140 receives ACK PDU 670, the DRM agent 140 can generate TRANSACTION_ID MDU 674 from the transaction ID included in ACK PDU 670 and send it to the DRM entity 160 (process 672). When the MDU conversion module 162 receives TRANSACTION_ID MDU 674, the MDU conversion module 162 can generate ESTABLISH_WRITE_SESSION CMD 378 (process 676). Subsequent processes may be equivalent to those after process 374 of FIG. 3.

FIG. 7 depicts a re-connection process of license information transfer when the license information transfer process of FIG. 5 fails. When the DRM agent module 140 receives REOPEN PDU 710, the DRM agent module 140 generates TRANSACTION_ID MDU 714 by using the transaction ID included in REOPEN PDU 710 (process 712). When the MDU conversion module 162 receives TRANSACTION_ID MDU 714, the MDU conversion module 162 can generate RECOVER_MOVE_SESSION CMD 718 (process 716) and transmit it to the card 214 for process (process 720). The process 720 mentioned here corresponds to, for example, a process of extracting the transaction ID used in the previous communication and included in the log information; extracting the individual public key of the communication-counterpart DRM entity used in the previous communication; generating a third session key by using the random number generator; encrypting the generated third session key with the individual public key of the communication-counterpart DRM entity; and concatenating the encrypted third session key with the transaction ID to output it. When the process 720 ends, the MDU conversion module 162 receives data (the transaction ID and the encrypted third session key) 722 to check that no error is present, and then generates RECOVER_KEY MDU 726 (process 724). When the DRM agent 140 receives RECOVER_KEY MDU 726, the DRM agent 140 generates RECOVER PDU 730 and transmits it to the communication destination (process 728). RECOVER_KEY MDU 726 includes information such as the message ID, the transaction ID, and the encrypted third session key.

After the transmission of RECOVER PDU 730, the DRM agent module 140 makes a transition to a state of waiting for LOG PDU 750. If this state continues longer than a predetermined period of time, the DRM agent module 140 can suspend the process while keeping the state.

When the DRM agent module 140 receives LOG PDU 750, the DRM agent module 140 generates LOG MDU 754 from LOG PDU 750 (process 752). LOG MDU 754 includes information obtained by concatenating hash values of the second session key, the transaction ID, the state of license information transfer, and the third session key with the transaction ID and the state of the license information. LOG MDU 754 is converted by the MDU conversion module 162 to VERIFY_HASHED_LOG CMD 758 (process 736) and transmitted to the card 240 and then processed (process 760). In the process 760, the transaction ID received in RECOVER_MOVE_SESSION CMD 718 and the transaction ID received in VERIFY_HASHED_LOG CMD 758 are compared with each other. If they match, hash values of this transaction ID, the third session key generated at the random number generator in the process 720, the second session key stored in the log information, and the state of the license information sent are calculated, and then the calculated hash values are compared with the hash values received in VERIFY_HASHED_LOG CMD 758. If they match, in accordance with the state of the license information, a process of recovering the license information with a matching transaction ID is performed. For example, in the case where the license information is in an untransferred state at the transfer-destination DRM entity and the license information is in a transferred state at the transfer-source DRM entity, the state of the license information at the transfer-source DRM entity can be returned to an untransferred state. This result can be acquired by checking the status information. In this manner, when the license information is recovered, the license information number is set in the status information. The MDU conversion module 162 checks an error in the process 760 (process 762), and if the process is successful, it generates SEND_SCSR CMD 766 (process 764) to send it to the card 240 for process (process 768). The process 768 corresponds to, for example, a process of transmitting the license information number of the recovered license information. The MDU conversion module 162 checks that no error is present, and then converts the license information number to a format which can be recognized by the application 130 or the DRM agent module 140 (process 772). When the DRM agent module 140 receives a license information number 774, the DRM agent module 140 searches the content table for target license information to update the state, and then generates ACK PDU 778 to transmit it to the communication destination (process 776).

After the transmission of ACK PDU 778, the DRM agent module 140 makes a transition to a state of waiting for GET_LICENSE PDU 790. If this state continues longer than a predetermined period of time, the DRM agent module 140 can suspend the process while keeping the state. When the DRM agent module 140 receives GET_LICENSE PDU 790, the DRM agent module 140 can perform processes from the process 1412 of FIG. 14.

In the license information transfer process, there may be a case where the license information is desired to be temporarily read on a decoder (170). In this case, it is preferable to provide a protocol which permits the reading on condition that the license information should be discarded after reading without writing back the license information to the DRM entity once read on the decoder.

FIG. 8 depicts a procedure when the license information is temporarily read for use. This process is assumed to be performed subsequently to the process 548 of FIG. 5. When the DRM agent module 140 receives GET_LICENSE PDU 810, the DRM agent module 140 generates DESTINATION_KEY MDU 814 by using the second session key encrypted with the first session key and the license information list in GET_LICENSE PDU 810 (process 812). When the MDU conversion module 162 receives DESTINATION_KEY MDU 814, the MDU conversion module 162 generates ESTABLISH_PLAY_SESSION CMD 818 by using the second session key encrypted with the first session key in the received command (process 816) and then transmits it to the card 240 for process (process 820). The process 820 corresponds to, for example, an operation of decrypting the encrypted data with the first session key to extract the second session key. When the process ends, the MDU conversion module 162 checks the presence of an error (process 822), and if no error is present, it generates READ_LICENSE CMD 832. At this time, the application 130 specifies a method of transferring the license information based on the license information list included in GET_LICENSE PDU 810 (process 826). Based on the transaction ID, the DRM agent module 140 searches the content table for a storage number of target license information, and then generates data 830 by combining the storage number and specification of the license information (process 828). READ_LICENSE CMD 832 is generated based on this data 830. As the reading method specified here, a predetermined method may be adopted without complying with the license information list included in GET_LICENSE PDU 810. If a transfer method is defined in advance, it is not necessary to include the license information in GET_LICENSE PDU 810. Conversely, if an unsupported license information list comes, the DRM agent module 140 or the application 130 can end the process without permitting a process of transferring the license information, or can return an error until a correct access condition is sent. When the card 240 receives READ_LICENSE CMD 832, the card 240 can determine whether the license information at the storage number can be read in accordance with the specified reading method, and if the license information can be read, it can read and set the license information in the memory.

The method of reading the license information corresponds to, for example, a read process and an export process. In the read process, the license information is temporarily read, and the license information is not left at the reading destination after its use. The number of times of execution of the read process may be limited. In the export process, the license information is read for the purpose of transferring it to another DRM module. Whether the license information is left at the DRM entity after the export may be determined by the DRM entity checking a flag in the license information. Whether the read process or the export process is used as a read method is determined by the DRM agent or application at the license information transfer source. That is, the reading destination of the license information in the export process is preferably a decoder DRM entity with a DRM conversion function present in the license information transfer source. Similarly, the license information number for reading the license information is preferably specified by the DRM agent or application at the license information transfer source. The number of times of execution of the export process may be limited. Since the above two processes are different from each other only in a course from reading the license information from the storage device 200 to storing the read information in a memory area for transfer, these processes other than the difference can be performed in common. Thus, these processes can be performed with one instruction instead of a plurality of instructions, thereby achieving commonality of the process contents.

If the license information can be transferred and the number of times of transfer of the license information is limited, the number of times is decreased. When the process ends, the MDU conversion module 162 checks the error state (process 836). If no error is present, the MDU conversion module 162 generates SEND_PLAY_LICENSE CMD 840 (process 866), and sends it to the card 240 for process (process 842). The process 842 corresponds to, for example, a process of encrypting the transferable license information with the second session key to send it. When the process 842 ends, the MDU conversion module checks an error, and if no error is present, it converts the outputted encrypted license information 844 to LICENSE MDU 848 (process 846). When the DRM agent 140 receives LICENSE MDU 848, the DRM agent 140 can generate RES_GET_LICENSE PDU 852 and transmit it to the communication counterpart (process 850). RES_GET_LICENSE PDU 852 includes information such as the message ID and the encrypted license information.

After the transmission of RES_GET_LICENSE PDU 852, the DRM agent module 140 makes a transition to a state of waiting for CLOSE PDU 870. If this state continues longer than a predetermined period of time, the DRM agent module 140 can suspend the process while keeping the state. When the DRM agent module 140 receives CLOSE PDU 870, the DRM agent module 140 releases the DRM entity module 160 (process 872), and generates CONFIRM PDU 876 and transmits it (process 874). CONFIRM PDU 876 includes information such as the message ID and the transaction ID.

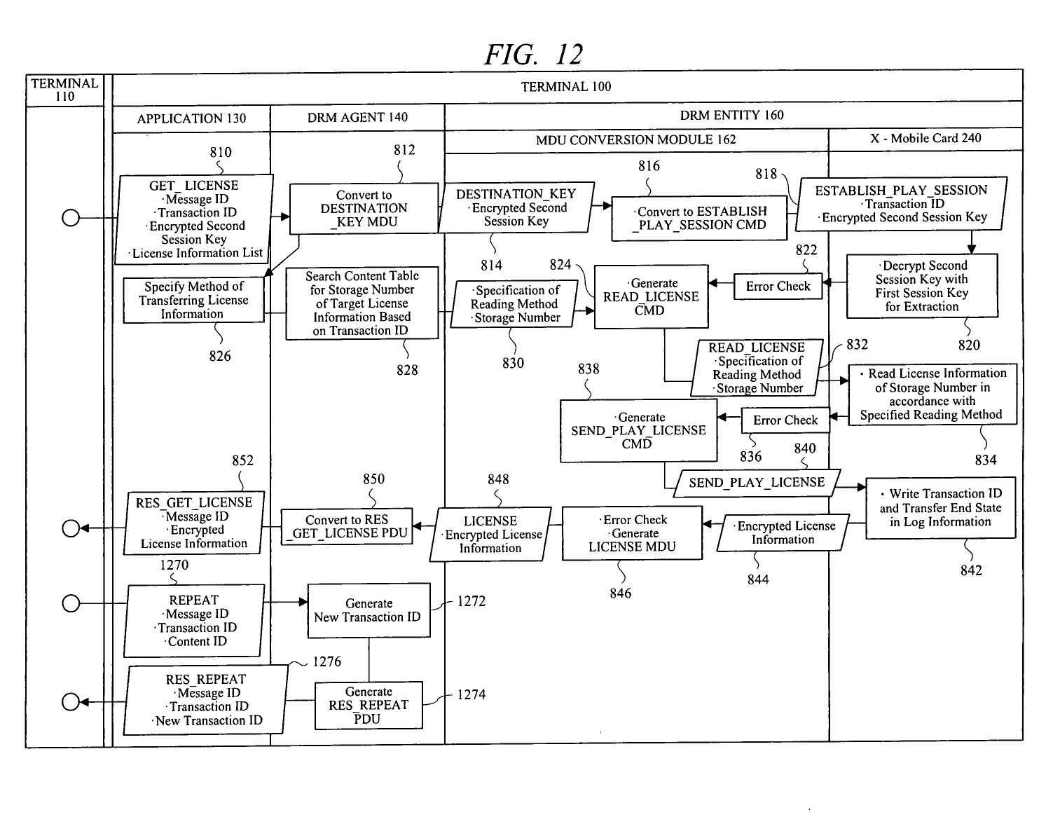

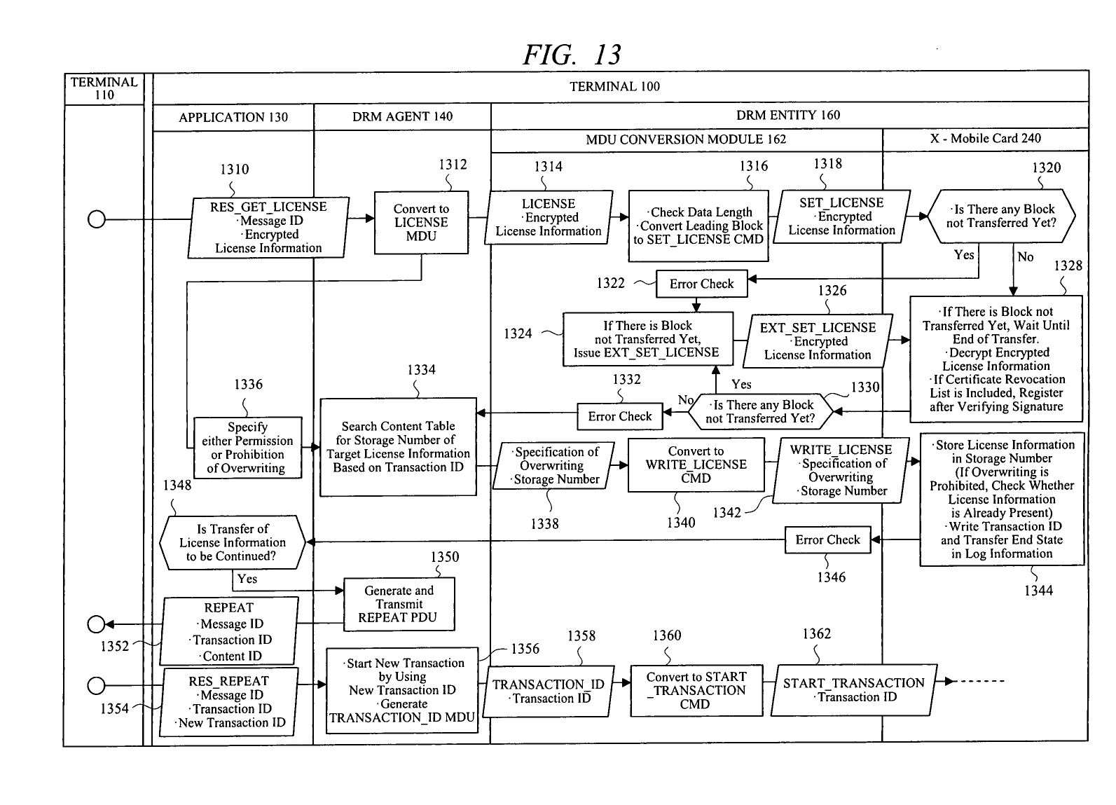

In the license information transfer process, when it is desired to perform the process of collectively transferring a plurality of license information, the DRM agent can omit an authentication process in the process of transferring the license information from the second time. In the license information transfer process, the license information is specified by the content ID and is managed by the corresponding transaction ID. Therefore, information about the content ID and the transaction ID is preferably managed in a one-to-one relation. Also, a new request for a process of transferring the license information is made together with a process of ending the immediately-preceding transaction. By doing so, effects of reduction in communication amount and increase in speed can be expected. Therefore, in the license information transfer process, the processes from the process 1572 to the process 1574 in FIG. 15 can be replaced with those from the process 1472 to the process 1474 in FIG. 14, and the processes from the process 450 to the process 462 in FIG. 4 are replaced with those from the process 1350 to the process 1360 in FIG. 13. Also, in the license information read process, the processes from the process 872 to the process 874 in FIG. 8 are replaced with those from the process 1272 to the process 1274 in FIG. 12.

In FIG. 14, when the DRM agent module 140 receives REPEAT PDU 1470, in addition to the content of the process 1572 on the previous transaction, the DRM agent module 140 generates a new transaction ID corresponding to the content ID included in REPEAT PDU 1470 (process 1472). After this process 1472, the DRM agent module 140 generates RES_REPEAT PDU 1476 by using the message ID and the transaction ID included in REPEAT PDU 1470 and the new transaction ID generated in the process 1472 and transmits it to the communication counterpart (process 1474). RES_REPEAT PDU 1476 includes information such as the message ID, the transaction ID, and the new transaction ID. Then, the DRM agent module 140 can makes a transition to a state of waiting for GET_LICENSE PDU 1410.

In FIG. 13, processes from process 1312 to process 1348 are equivalent to those from the process 412 to the process 448 in FIG. 4. In the process 448, if the application 130 determines that transfer is to be continued (process 1348), the application 130 specifies an ID of a content to be newly acquired to the DRM agent module 140, and the DRM agent module 140 generates a new message ID and also generates REPEAT PDU 1352 by using the generated message ID, the transaction ID that has been used so far, and the newly-specified content ID and then transfers it to the communication counterpart (process 1350).

After the transmission of REPEAT PDU 1352, the DRM agent module 140 makes a transition to a state of waiting for RES_REPEAT PDU 1354. If this state continues longer than a predetermined period of time, the DRM agent module 140 can suspend the process while keeping the state. When the DRM agent module 140 receives RES_REPEAT PDU 1354, the DRM agent module 140 regards the immediately-preceding transaction as being completed, and then starts a new transaction by using the sent new transaction ID. The DRM agent module 140 can generate TRANSACTION_ID MDU 1358 to send it to the MDU conversion module 162 (process 1356). Based on the sent TRANSACTION_ID MDU 1358, the MDU conversion module 162 can generate START_TRANSACTION CMD 1362 (process 1360). This process 1360 may be equivalent to the process 368 in FIG. 3. Thereafter, the process after the process 372 of FIG. 3 may be performed.

In FIG. 12, when the DRM agent module 140 receives REPEAT PDU 1270, in addition to the content of the process 872 on the previous transaction, the DRM agent module 140 generates a new transaction ID corresponding to the content ID included in REPEAT PDU 1270 (process 1272). When this process ends, the DRM agent module 140 generates RES_REPEAT PDU 1276 by using the message ID and the transaction ID included in REPEAT PDU 1270 and the new transaction ID generated in the process 1272 to send it to the communication counterpart (process 1274). Thereafter, the DRM agent module may make a transition to a state of waiting for GET_LICENSE PDU 810.

As described in the forgoing, according to the present embodiment, even if the storage device 200 for performing a process of transferring license information is detachably connected as is the case of the card 240 or even if the terminals (100, 110) and the storage device 200 are connected in a manner of one-to-many, many-to-one, or many-to-many connection, the terminals (100, 110) can efficiently perform the processes by acquiring the type, function, state of the storage device 200 and the type of license information stored therein.

In the foregoing, the invention made by the inventors of the present invention has been concretely described based on the embodiments. However, it is needless to say that the present invention is not limited to the foregoing embodiments and various modifications and alterations can be made within the scope of the present invention.

The present invention can be used for devices and systems handling content data and its license information.

What is claimed is:

1. A storage device comprising:
a memory for storing externally-provided data; a non-volatile memory for storing the data stored in said memory; and a controller which controls reading and writing of data from and to said memory and said non-volatile memory,
wherein, when a predetermined process is externally requested, said controller determines whether a data size of input data exceeds a data management size of said storage device based on the data size of said input data contained in a first divided input data of the input data externally provided for said predetermined process; said controller saves divided input data of said input data retained in said memory in said non-volatile memory in accordance with the determination result; when receiving an n-th divided input data of said input data from outside, said controller reads said divided input data saved in said non-volatile memory to said memory; and said controller performs said predetermined process by using said n-th divided input data in said memory and said divided input data read from said non-volatile memory.

2. The storage device according to claim 1,
wherein said controller determines whether a data size of output data exceeds said data management size based on a data size of output data contained in a first divided output data of the output data to be outputted to the outside as a result of said predetermined process; said controller saves divided output data other than said first divided output data of said output data in said non-volatile memory in accordance with the determination result; and when an m-th divided output data of said output data is saved in said non-volatile memory, said controller outputs said first divided output data in said memory to the outside and/or outputs said divided output data in said non-volatile memory to the outside via said memory.

3. The storage device according to claim 2,
wherein, upon externally-provided request, said controller outputs said divided output data in said non-volatile memory to the outside via said memory.

4. The storage device according to claim 1,
wherein said controller allocates a save area for saving said divided input data in said non-volatile memory in accordance with the determination result whether the data size of said input data exceeds the data management size of said storage device.

5. The storage device according to claim 1,
wherein said controller allocates a save area for saving said divided output data in said non-volatile memory in accordance with the determination result whether the data size of said output data exceeds the data management size of said storage device.

6. The storage device according to claim 1,
wherein, while the input data for said predetermined process is externally inputted and stored, said memory stores input data for another process different from said predetermined process.

7. The storage device according to claim 1,
wherein said storage device is connectable to an information processing device,
said information processing device comprises:
an agent module which controls communication between the information processing device and another information processing device; and
an entity module which converts a communication scheme with said agent module to a communication scheme with said storage device in accordance with a type of said storage device, and
said agent module and said entity module request said controller and said memory of said storage device to perform a predetermined process for data associated with license information, and divide and transfer said data for said predetermined process.

8. An information processing device having a storage device,
said storage device comprising: a memory for storing externally-provided data; a non-volatile memory for storing the data stored in said memory; and a controller which controls reading and writing of data from and to said memory and said non-volatile memory,
wherein, when a predetermined process is externally requested, said controller determines whether a data size of input data exceeds a data management size of said storage device based on the data size of said input data contained in a first divided input data of the input data externally provided for said predetermined process; said controller saves divided input data of said input data retained in said memory in said non-volatile memory in accordance with the determination result; when receiving an n-th divided input data of said input data from outside, said controller reads said divided input data saved in said non-volatile memory to said memory; and said controller performs said predetermined process by using said n-th divided input data in said memory and said divided input data read from said non-volatile memory, and
said information processing device comprising:
an agent module which controls communication between the information processing device and another information processing device; and
an entity module which converts a communication scheme with said agent module to a communication scheme with said storage device in accordance with a type of said storage device,
wherein said agent module and said entity module request said controller and said memory of said storage device to perform a predetermined process for data associated with license information, and divide and transfer said data for said predetermined process.
